(19) United States
(12) Patent Application Publication
(10) Pub. No.: US 2026/0352318 A1
(43) Pub. Date: Nov. 5, 2026

(54) MONITORING MOBILE SATELLITE BEAM RESOURCE ALLOCATION

(71) Applicant: Viasat, Inc., Carlsbad, CA (US)

(72) Inventor: Nicholas G. BERNDSEN, Parker, CO (US)

(21) Appl. No.: 19/488,567

(22) PCT Filed: Jun. 1, 2023
(86) PCT No.: PCT/US2023/024172

§ 371 Date: Nov. 26, 2025

(51) Int. Cl. H04B 7/185; H04B 7/204

(52) U.S. Cl. CPC H04B 7/18513; H04B 7/2041

(57) ABSTRACT

Methods, systems, and devices for monitoring mobile satellite beam resource allocation are described. A communication service may be provided to mobile terminals associated with a set of resource elements via spot beams that track movement of the mobile terminals. A communication service monitor may obtain, for each of multiple time periods, information associated with the mobile terminals, including geographic locations, resource element allocations, and other information associated with each mobile terminal. The communication service monitor may provide a map and, for display on the map for each time period, icons associated with each mobile terminal. The icons may reflect the information associated with the mobile terminals for the time period. The communication service monitor may also provide, for display on the map, visualizations indicating links between pairs of mobile terminals having metrics of interference that satisfy a threshold.

### CROSS REFERENCE

The present Application is a 371 national stage filing of International PCT Application No. PCT/US2023/024172 by Nicholas G. BERNDSEN entitled “MONITORING MOBILE SATELLITE BEAM RESOURCE ALLOCATION,” filed Jun. 1, 2023, which is assigned to the assignee hereof, and which is expressly incorporated by reference in its entirety herein.

### FIELD OF TECHNOLOGY

The following relates generally to communications, including monitoring mobile satellite beam resource allocation.

### BACKGROUND

Communications devices may communicate with one another using wired connections, wireless (e.g., radio frequency (RF)) connections, or both. Wireless communications between devices may be performed using a wireless spectrum that has been designated for a service provider, wireless technology, or both. In some examples, the amount of information that can be communicated via a wireless communications network is based on an amount of wireless spectrum designated to the service provider, and an amount of frequency reuse within the region in which service is provided. Satellite communications may use beamforming to establish beams to increase frequency reuse, however, providing a high level of frequency reuse in satellite communication systems employing beamforming presents challenges.

### SUMMARY

The described techniques relate to improved methods, systems, devices, and apparatuses that support monitoring mobile satellite beam resource allocation. For example, the described techniques provide for monitoring a communication service provided to mobile terminals associated with a set of resource elements via spot beams that track movement of the mobile terminals. A communication service monitor may obtain, for each of multiple time periods, information associated with the mobile terminals, including geographic locations, resource element allocations, and other information associated with each mobile terminal. The communication service monitor may provide a map and, for display on the map for each time period, icons associated with each mobile terminal. The icons may reflect the information associated with the mobile terminals for the time period. The communication service monitor may also provide, for display on the map, visualizations indicating pairs of mobile terminals having metrics of interference that satisfy a threshold. By doing this, a graphical representation of deconfliction boundaries and assigned resource elements (e.g., time/frequency/power) to beams may be shown.

### BRIEF DESCRIPTION OF THE DRAWINGS

FIG. 1 shows an example of a satellite communication system that supports monitoring mobile satellite beam resource allocation in accordance with examples described herein.

FIGS. 2A and 2B show examples of resources and resource elements for a satellite communication system that support monitoring mobile satellite beam resource allocation in accordance with examples described herein.

FIG. 3 illustrates an example of a satellite communication system that supports monitoring mobile satellite beam resource allocation in accordance with examples as disclosed herein.

FIG. 4 illustrates an example of another satellite communication system that supports monitoring mobile satellite beam resource allocation in accordance with examples as disclosed herein.

FIG. 5 illustrates an example of a communication service monitor that supports monitoring mobile satellite beam resource allocation in accordance with examples as disclosed herein.

FIGS. 6A and 6B show examples of visualizations that support monitoring mobile satellite beam resource allocation in accordance with examples as disclosed herein.

FIG. 7 illustrates an example representation of a set of information associated with a mobile terminal that supports monitoring mobile satellite beam resource allocation in accordance with examples as disclosed herein.

FIG. 8 shows a block diagram of a beam manager and communication service monitor that supports monitoring mobile satellite beam resource allocation in accordance with examples as disclosed herein.

FIG. 9 shows a block diagram of a communication service monitor that supports monitoring mobile satellite beam resource allocation in accordance with examples as disclosed herein.

FIG. 10 shows a flowchart illustrating a method that supports monitoring mobile satellite beam resource allocation in accordance with examples as disclosed herein.

### DETAILED DESCRIPTION

In some communication services, a set of resource elements (e.g., elements spanning one or more of time, frequency, and polarization) may be used for providing communication service to mobile terminals over spot beams. For some of these communication services, beams may be associated with mobile terminals, and may track the mobile terminals as the mobile terminals move. Each beam may use one or more resource elements for providing the communication service to its respective mobile terminal. Additionally, more than one beam may concurrently use a same resource element to communicate with respective mobile terminals unless it causes interference between the beams. Because the mobile terminals move in different directions and at different speeds, it can be difficult to track the mobile terminals and monitor the resource elements being used to provide the communication service to the moving mobile terminals. For example, it may be difficult to identify pairs of mobile terminals that may be likely to interfere (e.g., due to using the same resource element while close to each other). This may make it difficult to troubleshoot and debug problems related to the resource elements used by the system.

Techniques are described for monitoring communication service provided to mobile terminals as the mobile terminals move. The techniques may allow a communication service to be provided to mobile terminals associated with a set of resource elements (e.g., via spot beams that track movement of the mobile terminals). A communication service monitor may obtain, for each of multiple time periods, geographic locations, resource element allocations, and other information associated with the mobile terminals. In some cases, the resource element allocations may include combinations of time slots, frequency channels, polarizations, and/or codes associated with each mobile terminal for each time period.

The communication service monitor may provide a map and, for display on the map for each time period, icons associated with each mobile terminal. The icons may reflect the resource element allocations and other information associated with the mobile terminals for the time period. In some cases, the communication service monitor may determine pairs of mobile terminals that have a metric of interference between them that satisfies a threshold and for each pair, provide, for display on the map, a visualization indicating a link between the mobile terminals of the pair. By doing this, a graphical representation of deconfliction boundaries and assigned resource elements may be shown on a map, which may aid in troubleshooting and debugging problems related to the resource elements used by the system.

The discussion herein generally refers to resource elements as being “associated with” mobile terminals. In some cases, the resource elements may alternatively be considered to be “associated with” the spot beams (e.g., beamformed spot beams) to which the mobile terminals are associated. Further, a resource element, spot beam, or mobile terminal may be considered to be associated with a resource element, spot beam, or mobile terminal by being assigned to that device. For example, a resource element may be associated with a mobile terminal when the resource element is assigned to the mobile terminal, or the mobile terminal is assigned to the resource element. In some cases, the resource element may be associated with a forward link or a return link of a mobile terminal or both. In many cases, the device being assigned to another device may be synonymous with the other device being assigned to the original device.

Aspects of the disclosure are initially described in the context of satellite communication systems. Aspects of the disclosure are further illustrated by and described with reference to apparatus diagrams, system diagrams, block diagrams, and flowcharts that relate to monitoring mobile satellite beam resource allocation.

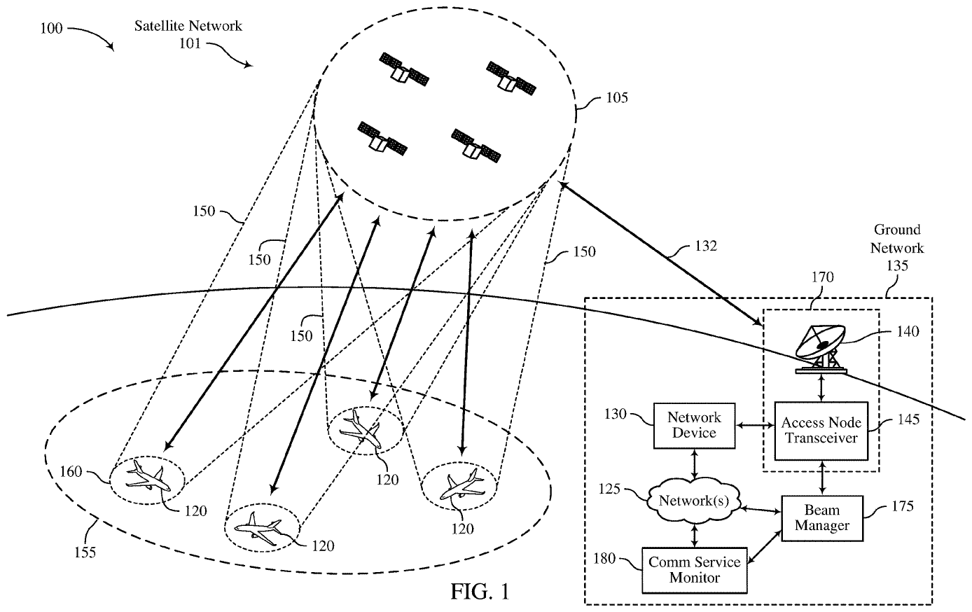

FIG. 1 shows an example of a satellite communication system 100 that supports monitoring mobile satellite beam resource allocation in accordance with examples described herein. Satellite communication system 100 may include a ground network 135 and a satellite network 101 configured to track and provide communication service to one or more mobile terminals 120.

The ground network 135 may include a collection of earth stations 170 having access nodes 140 configured to communicate with the satellite network 101 via a feeder link 132 (e.g., one or more satellite beams). The access nodes 140 may be coupled with access node transceivers 145 that are configured to process signals received from and to be transmitted through corresponding access node(s) 140. The access node transceivers 145 may also be configured to interface with a network 125 (e.g., the Internet) e.g., via a network device 130 (e.g., a network operations center, satellite and gateway terminal command centers, or other central processing centers or devices) that may provide an interface for communicating with the network 125.

The ground network 135 may also include a beam manager 175 for controlling the tracking of mobile terminals as communication service is provided to the mobile terminals via spot beams (e.g., beamformed spot beams) and coordinating resource elements used by the beams, as discussed herein. Beam manager 175 may retrieve information (e.g., associated with the satellite network 101 and the terminals 120) from the satellite network 101 (e.g., via feeder link 132 and an access node 140) for performing the controlling and coordinating, and may send commands (e.g., to the satellite network 101 and/or the terminals 120) accordingly (e.g., via the access node and feeder link). Beam manager 175 may also be configured to interface with the network 125. In some examples, satellite network 101 may include beam manager 175 instead of the ground network 135. For example, beam manager 175 may be positioned on a satellite 105.

The ground network 135 may also include a communication service monitor 180 for monitoring the locations, resource element allocations, and other information associated with the moving mobile terminals, as discussed herein. Communication service monitor 180 may obtain information (e.g., locations, resource elements) associated with each mobile terminal 120 (e.g., from beam manager 175 or the satellite network 101). The information may be obtained for a plurality of time periods as the mobile terminals move. In some examples, the information may be obtained directly or indirectly (e.g., via network 125) from beam manager 175 or access node 140. In some examples, communication service monitor 180 may be combined with beam manager 175. Communication service monitor 180 may generate icons for each time period based on the obtained information and provide the icons for display on locations of a map respectively corresponding to the locations of the mobile terminals.

Terminals 120 may include various devices configured to communicate signals with the satellite network 101. Although terminals 120 are illustrated as being on aircraft, terminals 120 may include fixed terminals (e.g., ground-based stationary terminals) or mobile terminals mounted on mobile platforms (e.g., boats, aircraft, ground-based vehicles, and the like), or a combination of fixed and mobile terminals. A terminal 120 may communicate data and information with an access node 140 via the satellite network 101. The data and information may be communicated with a destination device such as a network device 130, or some other device or distributed server associated with a network 125.

Satellite network 101 may include one or more satellites 105 (e.g., a single satellite 105 or a network of satellites) that are deployed in space orbits (e.g., low earth orbits, medium earth orbits, geosynchronous orbits, geostationary orbits, etc.). Each satellite 105 included in satellite network 101 may be equipped with one or more antennas (e.g., a single antenna or an antenna array), which may also be referred to as antenna elements. The ground network 135 may also contain access nodes 140 with one or more antenna elements.

Terminals 120 may include an antenna assembly which may also include various hardware for mounting an antenna. An antenna assembly may also include circuits and/or processors for converting (e.g., performing frequency conversion, modulating/demodulating, multiplexing/demultiplexing, filtering, forwarding, etc.) between radio frequency (RF) satellite communication signals, and satellite terminal communications signals transmitted between the antenna and a satellite terminal receiver. For mobile terminals, the antenna assembly may be mounted on the outside of the mobile platform (e.g., outside of the fuselage of an aircraft). Additionally, or alternatively, the terminal 120 may include a transceiver, which may be mounted on the inside or outside of the mobile platform and may include circuits and/or processors for performing various RF signal operations (e.g., receiving, performing frequency conversion, modulating/demodulating, multiplexing/demultiplexing, etc.).

Beam manager 175 may use the one or more satellites to support beamforming techniques within the coverage area 155 of the satellite communication system to increase a utilization of resources used for communications. Beam manager 175 may employ beamforming, including using multiple-input multiple-output (MIMO) techniques, to exploit multipath signal propagation and increase spectral efficiency by transmitting or receiving multiple signals via different spatial layers over the same frequency resources. Beam manager 175 may cause multiple signals, for example, to be transmitted by a transmitting device (e.g., a satellite 105) via a set of antennas in accordance with a set of weighting coefficients. Likewise, the multiple signals may be received by a receiving device (e.g., a terminal 120) via a set of antennas in accordance with a set of weighting coefficients. Each of the multiple signals may be associated with a separate spatial stream and may carry bits associated with the same data stream (e.g., the same codeword) or different data streams (e.g., different codewords).

In some examples, some or all of the antenna elements on the satellites 105, the ground network 135, and/or the terminals 120 may be arranged as an array of constituent receive and/or transmit feed elements that cooperate to enable various examples of on-board beamforming (OBBF), ground-based beamforming (GBBF), end-to-end beamforming, or other types of beamforming. In the GBBF implementation, there may be multiple transmit or receive antennas on the ground network access node(s).

Beam manager 175 may determine weighting coefficients to apply to the set of antennas. For example, for N spatial layers to be formed, beam manager 175 may utilize an (Mx N) MIMO matrix, where M may represent the quantity of antennas of the set of antennas. In some examples, M may be equal to N. Beam manager 175 may determine the MIMO matrix based on a channel matrix and may use the MIMO matrix to isolate the different spatial layers of the channel. In some examples, beam manager 175 may select the weighting coefficients to emphasize signals transmitted using the different spatial layers while reducing interference of signals transmitted in the other spatial layers. Accordingly, processing signals received at each antenna of the set of antennas (e.g., a signal received at the set of antennas) using the MIMO matrix may result in multiple signals being output, where each of the multiple signals may correspond to one of the spatial layers. In some examples, the weighting coefficients used for MIMO communications may be referred to as beam coefficients or beamforming coefficients, and the multiple spatial layers may be referred to as beams or spot beams.

Beam manager 175 may determine the elements of the MIMO matrix used to form the spatial layers of the channel based on channel sounding probes. Channel sounding probes may include reference signals transmitted periodically between satellite network 101 and a device (e.g., a terminal 120) coupled with the satellite network. For example, a channel sounding probe may be periodically transmitted from a terminal 120 to a satellite 105, or from the satellite to the terminal, or both, and may include a sequence that is known to the transmitter and receiver (e.g., based on a terminal identifier or other parameters known to the transmitter and receiver). The receiving device (e.g., the terminal or the satellite) may use the received channel sounding probe to evaluate the connection by correlating the received channel sounding probe to the expected signal for the channel sounding probe (e.g., to determine a signal strength, an interference, etc.) and make decisions based thereon. Due to the periodicity of the signal, the receiving device may know when the signal should be received.

Beam manager 175 may use beamforming techniques to shape or steer a communication beam along a spatial path between one or more satellites and a mobile terminal 120 within a geographic area. Beam manager 175 may cause a communication beam to be formed by determining weighting coefficients for antenna elements of an antenna array that result in the signals transmitted from or received at the antenna elements being combined such that signals propagating in a particular orientation with respect to an antenna array experience constructive interference while others experience destructive interference. Thus, beamforming may be used to transmit signals having energy that is focused in a direction of a communication beam and to receive signals that arrive in a direction of the communication with increased signal power (relative to the absence of beamforming). Beam manager 175 may use the weighting coefficients to apply amplitude offsets, phase offsets, or both to signals carried via the antennas.

In some examples, beam manager 175 may apply the weighting coefficients to the antennas to form multiple beams, each associated with a different direction, where the multiple beams may be used to communicate multiple signals having the same frequency at the same time to different user terminals. This may be referred to as Multiuser MIMO. The weighting coefficients used for beamforming may be referred to as beam coefficients, and the multiple signals may be referred to as beam signals. The resulting beams may be referred to herein as beamformed spot beams, spot beams, or beams.

Beam manager 175 may calculate the amplitude and phase of each weighting coefficient given the antenna array and reflector geometry and location and the desired beam locations. However, due to inaccuracies (e.g., in the satellite locations, array orientation, geometry, atmospheric scintillation effects, etc.), such an approach may be impractical. Instead, beam manager 175 may calculate the weighting coefficients using continuous or periodic measurements of the MIMO propagation channel characteristics (e.g., pairwise channels from each system antenna element to each terminal antenna element) and adjusting the weighting coefficients based on the changing channel characteristics. The measured MIMO channel characteristics may include pairwise gain and phase response and noise level and may be referred to as MIMO channel state information (CSI). Once the MIMO CSI is available, beam manager 175 may derive the weighting coefficients by solving a set of equations or applying a set of adaptation formulas. Various beamformer calculation and adaptation techniques may be used, including minimum mean square (MMSE) beamformer, zero forcing beamformer, MIMO sphere decoder, and others.

The measurement of MIMO CSI may include the collaboration of at least one terminal for each beam. The situation may be different for the forward link direction (from the satellites to the terminals) versus the return link direction (from the terminals to the satellites). In the return link, each terminal may transmit a channel probing signal that may be orthogonal to probing signals of the other terminals. The satellites may determine which channel probing signal is transmitted from each terminal and may process the signal to estimate the channel parameters of the channel corresponding to that terminal. As such, the MIMO CSI on the return link may be computed locally on the satellite side for terminals that transmit channel probing signals. In contrast, on the forward link, the satellites may transmit channel probing signals. Different antenna elements may transmit signals that are orthogonal to each other. Each terminal tasked to compute MIMO CSI may do so by processing the probing signal corresponding to each transmit antenna element. Further, each such terminal may transmit the MIMO CSI back to a satellite using a return link control channel.

The spot beams generated that way may be tailored to the MIMO CSI provided by the user terminals and each beam may illuminate the direction of each such terminal. Each beam has a finite coverage area 160 (e.g., several km diameter) and may therefore illuminate additional terminals that may be in the vicinity of the CSI generating terminal. These additional terminals may not provide CSI, as this may unnecessarily increase the CSI reporting channel overhead. The terminal that is used to provide MIMO CSI per beam may be considered the reference terminal for that beam. A reference terminal may be a mobile terminal. In some examples, the coverage area 160 of a beam may be determined based on the wavelength of the carrier wave and the diameter of the aperture. The coverage area 160 may correspond, e.g., to a footprint where the power level of the beam is above a threshold, or where the power level drop-off away from the center of the beam is less than a threshold amount (e.g., 3 decibels (dB) or 6 dB). In some examples, the coverage area 160 may be based on a beam width of the beam (e.g., at the threshold power level).

In some examples, one or more aircraft-based terminals 120 may be sufficiently separated in distance from each other and from the other aircraft, so that beam manager 175 may use a separate beam for each of the one or more terminals. In some examples, two or more of the terminals 120 may be in close proximity (e.g., at an airport) such that beam manager 175 may illuminate the terminals by a same beam. In the former case, each terminal on an aircraft may be a reference terminal for its beam, while in the latter case, one of several terminals on aircraft may serve as a reference terminal for the beam.

As the mobile terminal 120 moves in the airspace, the MIMO CSI may change, causing the direction of the beam to change. Beam manager 175 may adjust the beam direction based on the changed MIMO CSI so that the reference terminal may remain at or near the center of the beam. Therefore, as the reference terminal moves, the beam may follow its movement, as further explained herein.

Beam manager 175 may associate the spot beams with a set of resources of the satellite communication system 100. The set of resources may include, e.g., frequency resources, time resources, and polarization resources. For example, a given frequency range for the satellite communication system 100 may comprise frequency resources or channels, and a given amount of time may comprise different recurring time slots. For example, beam manager 175 may use a frequency channel to carry a signal (e.g., a modulated signal carried in a spot beam) on one of the recurring time slots. By doing this, spot beams may overlap spatially without interfering if they are associated with different frequency/time resource combinations. In addition, beam manager 175 may use multiple polarizations such that two spot beams may overlap spatially without interfering if they are associated with different polarizations.

Thus, spot beams may overlap spatially without interfering if they are associated with different combinations of the resources (e.g., different frequency channel/time slot/polarization combinations). The different combinations may be known as resource elements that together form a set of resource elements that may be used by beam manager 175 for communicating signals over a beam. Beam manager 175 may control the association of the beams with the resource elements and determine when to assign and reassign the resource elements to the beams. Beam manager 175 may also control the amount of power to allocate for each beam and when to adjust the power for each beam.

Beam manager 175 may adjust the individual coverage areas or footprints of the spot beams (e.g., by adjusting the weighting coefficients) so as to track (e.g., move in concert with) the respective mobile terminals.

As mobile terminals 120 move and are tracked by respective beams 150, communication service monitor 180 may obtain information (e.g., the location and resource element allocation) associated with each mobile terminal 120 over a plurality of time periods, generate corresponding icons representative of the mobile terminals 120 for each time period, and provide the icons for display on a map for the time period.

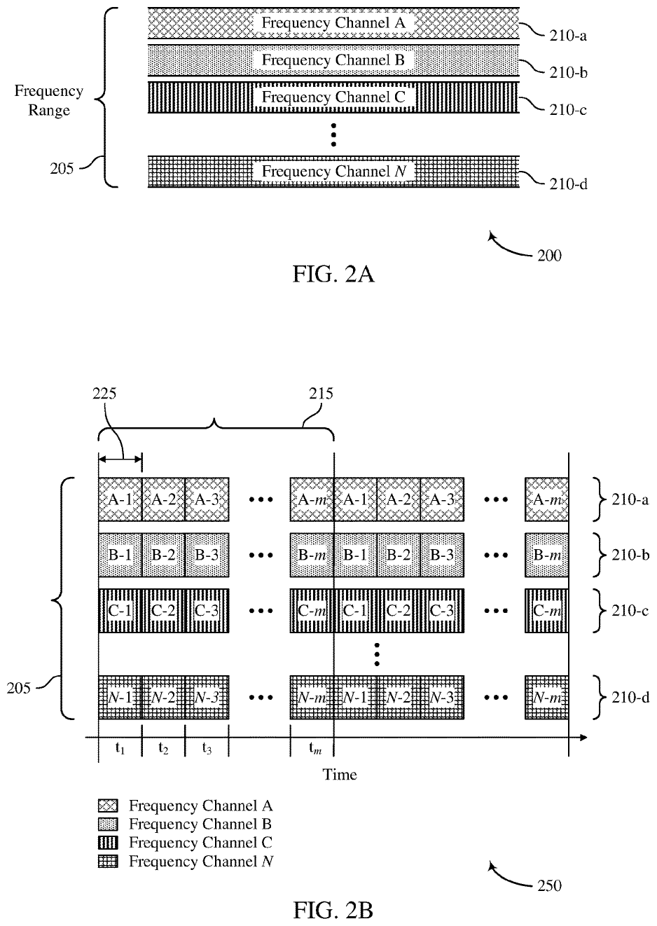

FIG. 2A shows an example of resources 200 for a satellite communication system that support monitoring mobile satellite beam resource allocation in accordance with examples described herein. Resources 200 may correspond to frequency divisions of a satellite communication system. For example, a frequency range 205 (e.g., a frequency band) may comprise a set of different frequency resources or frequency channels 210 (e.g., frequency channel 210-a, frequency channel 210-b, frequency channel 210-c, frequency channel 210-d) that carry signals between the satellite network and the terminals. The resources 200 may correspond to the frequency channels 210 of the frequency range 205.

Each frequency channel 210 may carry signals associated with a single terminal (e.g., at a time). For example, each frequency channel 210 may carry a single modulated signal. Information (e.g., data, control information) may be modulated onto the modulated signal using a variety of single-carrier or multi-carrier modulation techniques (e.g., Orthogonal Frequency Division Multiplexing (OFDM), Direct Sequence Spread Spectrum (DSSS), linearly pre-coded OFDM (LP-OFDM)). A spot beam may be associated with one or more frequency channels 210 (e.g., by beam manager 175), to provide communication to and track mobile terminals.

In the example of FIG. 2A, the resources 200 may correspond to the frequency channels 210. That is, each frequency channel 210 may be a separate resource 200. As there are no other types of resources, the separate resources may also be resource elements in some examples. As such, in this example the number of available resource elements may correspond to the number of frequency channels, N.

FIG. 2B shows an example of resource elements 250 for a satellite communication system that support monitoring mobile satellite beam resource allocation in accordance with examples described herein. In this example, frequency channels 210 may again be used to carry signals associated with the terminals. In addition, the frequency channels 210 may be time multiplexed. That is, each frequency channel 210 may be configured to carry signals to and from the terminals in time slots that repeat after a period of time. For example, a time period 215 may be divided into a set of sub-periods or time slots t (e.g., time slot t₁, time slot t₂, time slot t₃, time slot tₘ) each having a length 225. Each frequency channel 210 may carry a signal to or from a different terminal during each time slot t, although in some cases multiple time slots within a time period 215 may be allocated to the same terminal. For example, each frequency channel 210 may carry a single modulated signal during each time slot t. Information (e.g., data, control information) may be modulated onto the modulated signal using a variety of single-carrier or multi-carrier modulation techniques (e.g., OFDM, DSSS, LP-OFDM) to provide communication to and track mobile terminals (e.g., by beam manager 175), as discussed herein.

At the completion of the time period 215, the process may repeat such that each frequency channel 210 may carry further signals associated with the different terminals in a resource period. As a result, beam manager 175 may use the frequency channel 210 for communication with the terminal during one time slot t per time period 215. In some examples, beam manager 175 may assign more than one time slot per time period to a terminal, and thus communication with the terminal may occur over more than one time slot per time period for the frequency channel 210. In some cases, assignment of spot beams to a set of resources (e.g., one or more resource elements) may be performed on a longer time scale than time period 215. That is, once assigned to one or more resource elements, a spot beam may continue to use the resource elements over multiple time periods 215 until the assignment is updated. In some cases, the resources may be associated with forward-link spot beams (e.g., for transmitting information to the mobile terminals) and/or return-link spot beams (e.g., for receiving information from the mobile terminals).

In the example of FIG. 2B, the resource elements 250 may correspond to the combinations of frequency channels 210 and time slots t in a time period 215. That is, each unique combination of frequency channel 210 and time slot t may be a separate resource element 250. As such, in this example the number of available resource elements may correspond to the number of frequency channels times the number of time slots, or N×m. Thus, this example may provide more resource elements than the example of FIG. 2A.

In addition to being multiplexed in time or frequency, different polarizations may be used to define the resource elements for assignment to spot beams. For example, a set of resource elements may include a first sub-set of resource elements associated with a first polarization and a second sub-set of resource elements associated with a second, orthogonal, polarization. The first and second polarizations may be orthogonal polarizations, and may be linearly polarized or circularly polarized (e.g., a right-hand circular polarization (RHCP), a left-hand circular polarization (LHCP)). Thus, a set of resource elements available to beam manager 175 for assignment to spot beams may be defined according to frequency resources (e.g., frequency channels), time resources (e.g., sub-periods of resource periods), or polarization resources.

In some examples, the types of resource elements may be combined. For example, in the same system, one or more frequency channels may be divided into time slots (e.g., as in FIG. 2B) and one or more other frequency channels may be used, undivided (e.g., as in FIG. 2A), as separate resource elements. Other combinations are also possible.

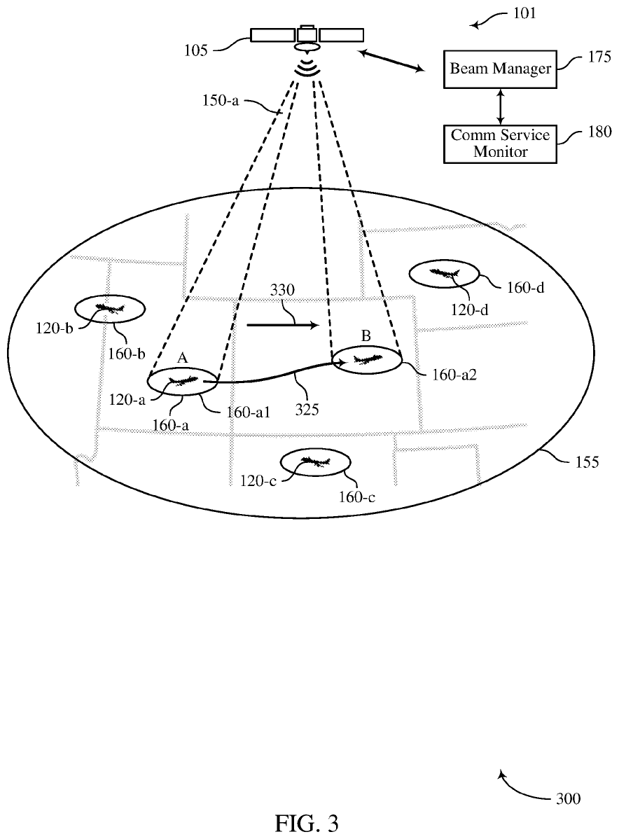

FIG. 3 illustrates an example of a satellite communication system 300 that supports monitoring mobile satellite beam resource allocation in accordance with examples as disclosed herein. The satellite communication system 300 may be an example of satellite communication system 100 as described with reference to FIG. 1 or aspects thereof. Satellite communication system 300 may include a satellite network 101 having one or more satellites 105 configured to generate spot beams 150 (e.g., beam 150-a) for communicating with a set of terminals 120 (e.g., terminals 120-a, 120-b, 120-c, 120-d) within a coverage area 155 of the satellite communication system, as directed by a beam manager 175. The information associated with the mobile terminals may be monitored for display by a communication service monitor 180. Spot beams may include, e.g., beamformed spot beams and may be referred to herein as spot beams or beams.

The terminals 120 may be located on movable platforms or vehicles, such as automobiles, boats, or aircraft, and thus may be considered to be mobile terminals 120. In some examples, each vehicle may include a single mobile terminal. In other examples, one or more vehicles may each include two or more mobile terminals. At least some of mobile terminals 120 may be multi-user mobile terminals, and thus the satellite communication system 300 may provide a communication service to multiple user devices (e.g., smartphones, laptops, tablets) connected via the mobile terminals 120.

In some examples, the satellite communication system 300 may provide communication service to the mobile terminals 120 via a set of movable spot beams 150 that track the mobile terminals, as controlled by beam manager 175, during movement of the mobile terminals. As the mobile terminals move, communication service monitor 180 may obtain and monitor locations, resource element allocations, and other information associated with the mobile terminals 120, as discussed herein. For the sake of clarity, only a single movable spot beam 150-a is illustrated in FIG. 3 associated with a single mobile terminal 120-a. Although not illustrated in FIG. 3, movable spot beams 150 may also be associated with one or more of the other mobile terminals 120.

In some examples, beam manager 175 may associate each spot beam 150 with a different mobile terminal 120. Each mobile terminal 120 associated with its own spot beam may also be considered to be a reference terminal. Each spot beam 150 may have a respective coverage area 160 (e.g., coverage areas 160-a, 160-b, 160-c, 160-d). The coverage area may correspond, for example, to a footprint where the power level of the beam is above a threshold, or where the power level drop-off away from the center of the beam is less than a threshold amount (e.g., 3 dB, 6 dB).

In some examples, a spot beam associated with a reference terminal may be formed (e.g., as controlled by beam manager 175) to include the terminal's physical location within the coverage area of the spot beam. For example, as shown in FIG. 3, mobile terminal 120-a, acting as a reference terminal, may be physically located within the coverage area 160-a of spot beam 150-a and mobile terminals 120-b, 120-c, and 120-d may be physically located within the coverage areas 160-b, 160-c, and 160-d of their respective spot beams (not shown). The satellite communication system 300 may provide communication service (e.g., via beam manager 175) to mobile terminal 120-a via spot beam 150-a.

In some examples, beam manager 175 may cause a spot beam to track a moving mobile terminal while communication service is provided to the terminal via the beam. For example, as mobile terminal 120-a physically moves from location A to location B, as indicated by arrow 325, spot beam 150-a may “move” so as to track the mobile terminal, as indicated by arrow 330. In some examples, to “move” a spot beam, beam manager 175 may change and apply the beamforming coefficients associated with the spot beam to the signal associated with the spot beam. This may change the directionality of the spot beam (e.g., “move” the beam) so that the coverage area of the spot beam changes (e.g., “moves”).

To follow or track a mobile terminal, the beamforming coefficients may be changed by beam manager 175 such that the coverage area of the spot beam may move to reflect the movement of (e.g., may be moved in concert with) the mobile terminal. For example, the beamforming coefficients may be changed such that the coverage area of the spot beam may move in one dimension, or in two dimensions, to spatially track the mobile terminal 120-a across the coverage area 155. Beam manager 175 may continually adjust the coverage area (e.g., by periodically changing the beamforming coefficients to provide continuous coverage) to continue to correspond with the moving physical location of the moving mobile terminal and thereby track the mobile terminal. For example, beam manager 175 may move the coverage area 160-a of spot beam 150-a (e.g., from coverage area 160-a1 to coverage area 160-a2) so as to encompass the physical location of mobile terminal 120-a as mobile terminal 120-a moves from location A to location B. This may allow communication service associated with the mobile terminal to be provided via the same spot beam as the mobile terminal moves through the coverage area of the satellite communication system. For example, beam manager 175 may provide continuous communication service to mobile terminal 120-a via spot beam 150-a without a handoff as the mobile terminal moves between location A and location B.

In some examples, to track the mobile terminal 120, beam manager 175 may adjust the coverage area 160 of the spot beam (e.g., move the spot beam) based on measurements of signals communicated with the mobile terminal. In some examples, the terminal 120 may provide channel state information back to satellite network 101 on a regular and periodic basis, and beam manager 175 may process this channel state information to compute appropriate beamforming coefficients such that the beam energy for the beam signal associated with an aircraft is focused on that aircraft. As the aircraft moves, the channel state information may change, which in turn may induce changes in the beam weight coefficients computed by beam manager 175. Through this beamformer adaptation process, the beam center may be co-located with the aircraft location continuously (may follow the aircraft).

Alternatively, beam manager 175 may use an initial estimate of where to move the beam based on the latest speed and direction of travel of the mobile terminal. In some examples, beam manager 175 may move the spot beam in such a manner that as the mobile terminal moves, the mobile terminal may remain centrally positioned within the coverage area. This may allow the SNR of the mobile terminal to remain high so that overall communication speed and spectral efficiency associated with the mobile terminal may also be high.

In some examples, beam manager 175 may determine the position of the mobile terminal based on information received from the mobile terminal, such as location coordinates (e.g., determined via a positioning system such as GPS), a speed, a direction or other information associated with the mobile terminal. In some examples, beam manager 175 may determine the position of the mobile terminal based on information external to the mobile terminal, such as based on radar or other signals.

In some examples, the satellite communication system may provide the communication service to one or more mobile terminals via spot beams associated with the terminals. For example, in FIG. 3, beam manager 175 may establish spot beams 150 for each of mobile terminals 120-a, 120-b, 120-c, and 120-d, and may provide the communication service to the terminals and track the mobile terminals as the mobile terminals move within the coverage area 155 of the satellite communication system.

In some examples, beam manager 175 may use initial channel state information to determine the locations of the mobile terminals. Beam manager 175 may determine the initial channel state information based on measurements (e.g., signal strengths) of initial signals communicated with (e.g., transmitted to or received from) the mobile terminals. The initial channel state information may be based on respective first locations (e.g., location A for mobile terminal 120-a) of the mobile terminals within the coverage area 155. In some examples, the initial signals may include respective initial channel sounding probes communicated with the mobile terminals.

In some examples, to generate the spot beams, beam manager 175 may apply beamforming coefficients to convert between beam signals associated with each of the spot beams and component signals associated with a plurality of antenna elements of the satellite communication system. For example, to generate a spot beam for transmitting information to a mobile terminal, beam manager 175 may apply beamforming coefficients to beam signals (that contain information for transmission to the mobile terminals) to obtain component signals that may be applied to the antenna elements; and to generate a spot beam for receiving information from a mobile terminal, beam manager 175 may apply beamforming coefficients to component signals received from multiple mobile terminals at the antenna elements to obtain multiple beam signals that each contain the information transmitted within the coverage area of a given spot beam (e.g., that enhance the signals transmitted within the coverage area of the spot beam and suppress signals transmitted from outside the coverage area of the spot beam). The beam manager may also determine power levels to allocate for the spot beams. In general, a beam may have a greater capability (e.g., data speed) at higher power levels.

The plurality of antenna elements may be positioned on one or more of the satellites 105 or may be positioned on components of a ground network (not shown) of the satellite communication system 300 (e.g., access nodes 140 of ground network 135 as shown in FIG. 1). Beam manager 175 may use the beamforming coefficients to form the spot beams 150 between the satellites 105 and the coverage areas 160. Beam manager 175 may base the beamforming coefficients on the initial channel state information so that the coverage areas 160 of the beams 150 may encompass the respective first locations (e.g., location A) of the associated terminals 120.

The spot beams 150 may be forward-link spot beams (e.g., for transmitting information to the mobile terminals) and/or return-link spot beams (e.g., for receiving information from the mobile terminals). For example, the beamforming coefficients may include a plurality of sets of forward-link beamforming coefficients and a plurality of sets of return-link beamforming coefficients.

Beam manager 175 may apply a first set of the forward-link beamforming coefficients at a first time to a set of forward-link beam signals to generate a first set of forward-link component signals for transmission to one or more mobile terminals via the antenna elements at the first time. Transmission of the first set of forward-link component signals to the mobile terminals via the antenna elements may form forward-link spot beams, each corresponding to one of the mobile terminals for the first time.

Beam manager 175 may apply a second set of the forward-link beamforming coefficients at a second time to the set of forward-link beam signals to generate a second set of forward-link component signals for transmission to the mobile terminals via the antenna elements at the second time. Transmission of the second set of forward-link component signals to the mobile terminals via the antenna elements may form the forward-link spot beams, each corresponding to the mobile terminals for the second time. One or more of the forward-link spot beams at the second time may have moved from the corresponding forward-link spot beams at the first time to track movement of corresponding mobile terminals.

On the return link, beam manager 175 may apply a first set of the return-link beamforming coefficients at a first time to return-link component signals received from the mobile terminals via the antenna elements at the first time. Applying the first set of the return-link beamforming coefficients may form return-link spot beams, each corresponding to one of the mobile terminals, for the first time.

Beam manager 175 may apply a second set of the return-link beamforming coefficients at a second time to return-link component signals received from the mobile terminals via the plurality of antenna elements at the second time. Applying the second set of the return-link beamforming coefficients may form the return-link spot beams for the second time. One or more of the return-link spot beams at the second time may have moved from the corresponding return-link spot beams at the first time to track movement of the corresponding mobile terminals.

In some examples, beam manager 175 may use subsequent channel state information to determine subsequent locations of the mobile terminals. Beam manager 175 may determine the subsequent channel state information based on measurements (e.g., signal strengths) of subsequent signals communicated with the mobile terminals. The subsequent channel state information may be based on respective second locations (e.g., location B for mobile terminal 120-a) of the mobile terminals within the coverage area 155. Differences between the initial channel state information and the subsequent channel state information may be based on movement of the mobile terminals to the respective second locations.

In some examples, beam manager 175 may revise the beamforming coefficients and apply them to convert between the beam signals and the component signals associated with the plurality of antenna elements of the satellite network. The revised beamforming coefficients may be based on the subsequent channel state information so that the new coverage areas (e.g., coverage area 160-a2) of the beams may encompass the respective second locations (e.g., location B) of the mobile terminals.

The determination of subsequent locations of the mobile terminals and the revisions of the beamforming coefficients based thereon may be repeated by beam manager 175 as often and as long as desired. In this manner, the plurality of spot beams 150 may track movement of the reference terminals 120 throughout the coverage area 155 of the satellite communication system while communication service is provided to the terminals.

In some examples, the beamforming coefficients (e.g., initial beamforming coefficients and the revised beamforming coefficients) may include sets of beamforming coefficients. Each set of beamforming coefficients may correspond to a different time period for the set of spot beams. In some examples, the beamforming coefficients may be revised based on a characteristic, attribute, or condition satisfying (e.g., meeting, exceeding, and/or falling below) a threshold. For example, beam manager 175 may revise and apply beamforming coefficients based on a received signal quality (e.g., measured at the mobile terminal or at the satellite communication system) falling below a threshold. For example, the beamforming coefficients may be revised so that a power for the beam may increase. This may allow the signal quality associated with the mobile terminal to remain high so that overall communication speed and efficiency associated with the mobile terminal may also be high. In some examples, beam manager 175 may determine the received signal quality based on the subsequent channel state information.

In some examples, two or more beams may use different resource elements for providing communication services to the respective mobile terminals. For example, beam manager 175 may cause each beam to use a different resource element (e.g., a different combination of frequency channel, time slot, and polarization) to provide communications to its respective mobile terminal while tracking the mobile terminal. By using different resource elements, interference between the beams may be reduced or eliminated, even when the mobile terminals may be close to each other.

In some examples, two or more beams may use a same resource element for providing communication services to the respective mobile terminals. For example, beam manager 175 may cause two or more beams to use a same combination of frequency channel, time slot, and polarization to provide communications to respective mobile terminals while tracking the mobile terminals. This may be desirable when the mobile terminals are far enough apart so that the respective beams do not interfere with each other. By using the same resource elements, more beams may be used with a particular set of resources, thereby increasing frequency reuse.

As the mobile terminals move, communication service monitor 180 may obtain information (e.g., the locations, resource element allocations, and other information) associated with the mobile terminals, generate corresponding icons, and provide the icons for display on a map at locations associated with the mobile terminals. In some examples, communication service monitor 180 may obtain the information directly or indirectly from beam manager 175.

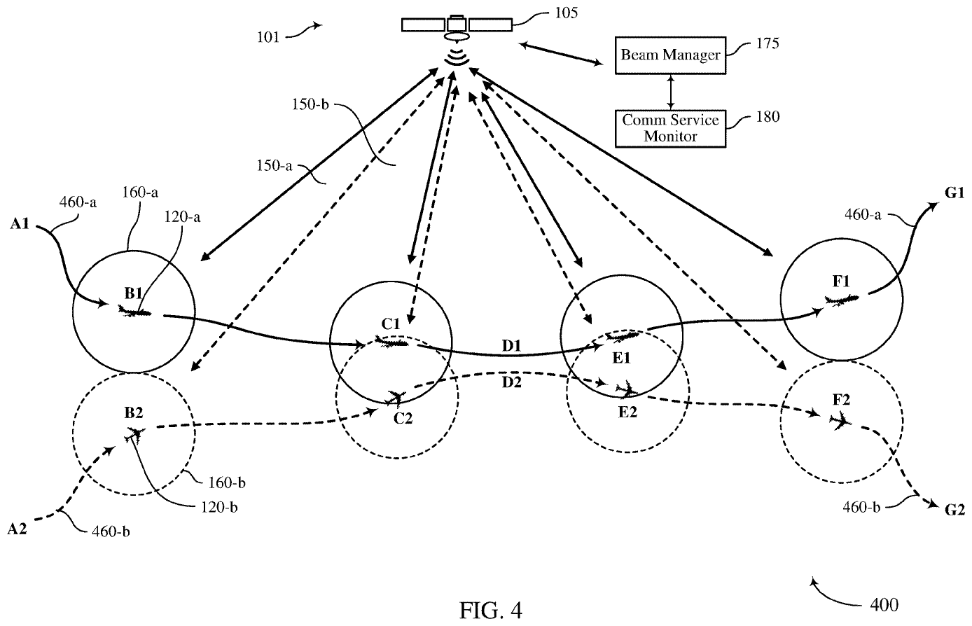

FIG. 4 illustrates an example of another satellite communication system 400 that supports monitoring mobile satellite beam resource allocation in accordance with examples as disclosed herein. The satellite communication system 400 may be an example of the satellite communication systems discussed herein, such as satellite communication systems 100 or 300 described with reference to FIG. 1 or FIG. 3 or aspects thereof.

Satellite communication system 400 may include a satellite network 101 having one or more satellites 105 configured to generate movable spot beams 150 (e.g., beams 150-a and 150-b) for communicating with mobile terminals 120 (e.g., mobile terminals 120-a and 120-b) as the spot beams track the mobile terminals, as controlled by beam manager 175 and monitored by communication service monitor 180, discussed herein.

In some examples, each spot beam 150 may be associated with a different mobile terminal 120. For example, beam manager 175 may associate spot beam 150-awith mobile terminal 120-a and spot beam 150-b with mobile terminal 120-b. The spot beams 150 may have coverage areas 160 (e.g., coverage areas 160-a and 160-b). For the sake of clarity, the moving spot beam 150-a and associated coverage area 160-acorresponding to moving mobile terminal 120-a are shown in solid lines, and the moving spot beam 150-b and corresponding coverage area 160-b corresponding to moving mobile terminal 120-b are shown in dashed lines.

FIG. 4 shows an example of two mobile terminals 120-a and 120-b passing close by each other as they travel along respective paths 460-a and 460-b. As with beam 150-b and corresponding coverage area 160-b, the path 460-b corresponding to mobile terminal 120-b is shown in dashed lines. The mobile terminals 120-a and 120-b may travel from respective start locations, represented by A1 and A2, to respective end locations, represented by G1 and G2, along paths 460-a and 460-b. Beams 150-a and 150-b are shown as being on aircraft, although other mobile platforms may also be used. Beams 150-a and 150-b may respectively track mobile terminals 120-a and 120-b (e.g., by beam manager 175 adjusting their respective coverage areas 160-a and 160-b in concert with the movement of the mobile terminals) while communication services are provided to the mobile terminals via the beams as the mobile terminals move along the paths.

As mobile terminals 120 move closer to each other, interference between the associated beams 150 may increase (e.g., when the beams use a same resource element). As discussed herein, beam manager 175 may cause one or more of the beams to switch to different resource elements to ameliorate the interference.

At a point along the paths 460-a and 460-b, represented by B1 and B2, the beams may begin to overlap each other, e.g., by the mobile terminals moving toward each other. As used herein, beams may be considered to be overlapping based on the relative positions of the respective coverage areas of the beams. For example, beams 150-a and 150-b may be overlapping when their respective coverage areas 160-a and 160-b overlap each other. In some cases, the coverage area of a beam may be centered on the position of the mobile terminal that the beam is tracking. For example, coverage areas 160-a and 160-b may be centered on the position of mobile terminals 120-a and 120-b, respectively. In some examples, the overlapping of coverage areas may be based on a distance between the corresponding mobile terminals.

Further along the paths 460-a and 460-b, mobile terminals 120-a and 120-b may arrive at another point, represented by C1 and C2, at which one or more of the mobile terminals may enter into the coverage area of a beam that is not supporting (e.g., not providing communication service to or tracking) the mobile terminal (e.g., by the mobile terminals continuing to move toward each other). For example, at C1/C2, mobile terminal 120-a may enter into coverage area 160-b of beam 150-b, and/or mobile terminal 120-b may enter into coverage area 160-a of beam 150-a. At some point before or after this, interference between beams 150-a and 150-b may rise to an unacceptable level. For example, an interference metric of one or both beams may satisfy (e.g., meet; or exceed; or meet or exceed) a threshold value. Steps may be taken (e.g., by beam manager 175) to ameliorate the interference (e.g., deconflict the beams), as discussed herein.

The mobile terminals 120-a and 120-b may each remain in the coverage areas 160-a and 160-b of both beams 150-a and 150-b until another point along the paths 460-a and 460-b, represented by E1 and E2. At that point, the mobile terminals may stop being in the coverage areas of the other's beam (e.g., by the mobile terminals moving away from each other). For example, at E1/E2, mobile terminal 120-a may stop being in the coverage area 160-b of beam 150-b and mobile terminal 120-b may stop being in the coverage area 160-a of beam 150-a. Even after the mobile terminals each stop being in the coverage area of the other terminal, the beams may still overlap. For example, at E1/E2, the coverage areas 160-a and 160-b of beams 150-a and 150-b may still overlap.

The beams 150-a and 150-b may remain overlapping until another point along the paths 460-a and 460-b, represented by F1 and F2. At that point, the beams 150-a and 150-b may stop overlapping each other (e.g., by the mobile terminals continuing to move away from each other). From that point to G1/G2 along the paths 460-a and 460-b, the beams 150-a and 150-b may remain apart and not overlapping, as long as the mobile terminals remain far enough apart from each other.

As discussed with respect to FIGS. 2A and 2B, beam manager 175 may use resource elements to provide communication service to mobile terminals via spot beams. In some examples, if beams do not conflict (e.g., the interference between the beams is low), the beams may use a same resource element for providing communication service to the respective mobile terminals. For example, as long as respective interference metrics of beams 150-a and 150-b remain below a threshold value, beam manager 175 may use the same resource element to provide communications to mobile terminals 120-a and 120-b via beams 150-a and 150-b, as discussed herein.

As the mobile terminals 120-a and 120-b move closer to each other (e.g., A1/A2 through B1/B2 and C1/C2 to D1/D2), interference between the corresponding beams 150-a and 150-b may increase. The increase in interference may mean that communication via the separate beams is subject to too much inter-beam interference (e.g., when using a same resource element). When the interference rises to a level (e.g., the interference metric of at least one of the beams satisfies a threshold value), steps may be taken by beam manager 175 to deconflict (e.g., ameliorate the interference) of the beams.

In some examples, the interference metric may correspond to a measured interference of one or more beams. For example, the interference metric may correspond to a signal strength of a beam associated with a terminal. In some examples, the signal strength associated with the terminal may be measured at a second terminal. Additionally, or alternatively, the interference metric may correspond to the degradation of a beam's signal (e.g., a lower SNR) and the threshold may correspond to a specific level of the metric or specific amount of degradation (e.g., 3 dB or 6 dB SNR loss). In some examples, the beam interference may be measured at the receiving device of the communication link. For example, the beam interference may be measured at mobile terminals (for forward links) or satellites (for return links).

In some examples, the interference metric may correspond to a channel correlation. For example, the interference metric may be based on a correlation between channel state information of two or more mobile terminals. The interference metric may be frequency dependent.

In some examples, the interference metric may correspond to an estimated interference of one or more beams. For example, the estimated interference may be based on the distance between the mobile terminals or on an algorithm that estimates the interference between the associated beams. In some examples, the interference metric may be based on a distance between the mobile terminals associated with the beams and the threshold may correspond to a specific distance. For example, the threshold may correspond to the distance between mobile terminals at which the coverage areas of the corresponding beams begin to overlap (e.g., at B1/B2), or at which one of the mobile terminals enters into the coverage area of the beam corresponding to another mobile terminal (e.g., at C1/C2), or somewhere in-between. Other distances are also possible.

In some examples, each beam may have multiple interference metric values. For example, the interference metrics may correspond to interference between pairs of beams and interference between each pair may be separately compared with the threshold value. So each beam may have multiple interference values, one each between the beam and one of the other beams. For example, for three beams A, B, and C that are close together, beam A may have two separate interference values, one corresponding to the interference between beams A and B and one corresponding to the interference between beams A and C. Interference between beam pairs AB, AC, and BC may be separately compared with the threshold value and demodulation may be performed for the pairs of beams whose interference metrics satisfy the threshold value.

In some examples, each beam may have a single interference value. For example, the interference metrics may correspond to interference between a beam and multiple other beams (e.g., all the other beams). For example, for the same three beams A, B, and C, beam A may have a single interference metric value corresponding to an aggregate interference between beam A and beams B and C. For each beam, the aggregate interference may be compared with the threshold value and demodulation may be performed for the beam(s) whose interference metrics satisfy the threshold value.

Returning to the example shown in FIG. 4, a same resource element A may be originally assigned to both beams 150-a and 150-b (e.g., at A1/A2) to provide communication service to their respective mobile terminals 120-a and 120-b. Mobile terminals 120-a and 120-b may be a substantial distance from each other at A1/A2, such that beams 150-a and 150-b do not conflict with each other (e.g., there may be little, if any, interference between beams 150-a and 150-b, even though the same resource element A is assigned to them). As such, an interference metric between beams 150-a and 150-b may be relatively low (e.g., below a threshold value). In some examples, the same resource element A may be semi-statically assigned to beams 150-a and 150-b (e.g., by beam manager 175), such that each terminal monitors the same resource element and/or transmits over the same resource element until the terminal receives an indication to switch its resource element.

The interference between the beams may rise to an unacceptable level (e.g., the interference metric may satisfy a first threshold value). In some examples, this may correspond to when one of mobile terminals 120 enters into the coverage area of the other beam 150 (e.g., at or near C1/C2). In some examples, this may correspond to mobile terminals 120-a and 120-b being between B1/B2 and C1/C2. Other locations may also be possible, based on when the interference metric value satisfies the first threshold value.

To ameliorate the interference, one or both of the beams may be changed to a different resource element (e.g., by beam manager 175). For example, in response to the interference metric satisfying the first threshold value, beam manager 175 may cause beam 150-b to switch resource elements (e.g., by assigning a resource element B to beam 150-b in place of resource element A) for providing communication service to mobile terminal 120-b. This may include changing one or more of the frequency channel, time slot, polarization, or other resource (e.g., one or more codes) associated with beam 150-b to be different than that used by beam 150-a. In some examples, resource element B may be orthogonal to resource element A.

After beam 150-b has been changed to a different resource element than beam 150-a, the interference between beams 150-a and 150-b may be greatly reduced or no longer present. Thus, the satellite communication system may continue to provide communication service to mobile terminal 120-b without a beam-to-beam handoff being performed.

When the interference (or potential interference) between the beams is no longer at an unacceptable level (e.g., an interference metric may not satisfy a second threshold value), beams 150-a and 150-b may again use a same resource element as each other. For example, beam 150-b may revert back to the original resource element (e.g., by beam manager 175 assigning resource element A back to beam 150-b in place of resource element B) for providing communication service to mobile terminal 120-b. Alternatively, beams 150-a and 150-b may continue to use different resource elements than each other. For example, instead of changing the resource element of beam 150-b back to resource element A, beam manager 175 may cause beam 150-b to continue using resource element B.

As the mobile terminals 120-a and 120-b move, communication service monitor 180 may obtain (e.g., for a plurality of time periods) the locations, resource element allocations, and other information associated with each mobile terminal and provide (e.g., for each time period) icons corresponding to the mobile terminals for display on a map. The communication service monitor 180 may also provide visualizations showing links between beams having interference therebetween that rise to the unacceptable level (e.g., the interference metric satisfying the first threshold value).

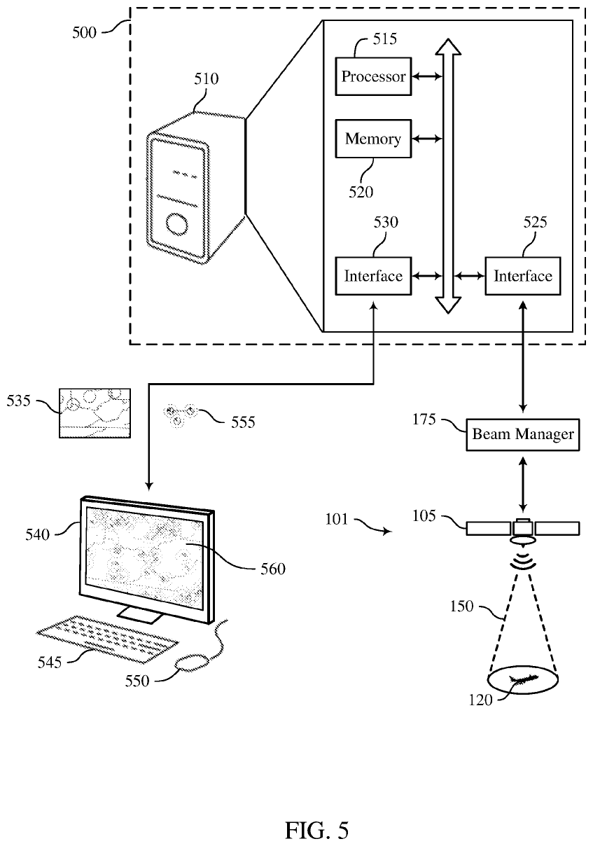

FIG. 5 illustrates an example of a communication service monitor 500 that supports monitoring mobile satellite beam resource allocation in accordance with examples as disclosed herein. Communication service monitor 500 may be an example of communication service monitor 180. Communication service monitor 500 may include a computer 510. Computer 510 may be a desktop computer, a laptop computer, or a network device, such as a server. In some examples, some or all of computer 510 may be hosted in the cloud. Computer 510 may include a hardware processor 515, a memory 520, and interfaces 525 and 530.

The memory 520 may include volatile memory (e.g., random access memory (RAM)) and/or non-volatile memory (e.g., read-only memory (ROM)). Other types of memory may also be possible. The memory 520 may store code that is computer-readable and computer-executable. The code may include instructions that, when executed by the processor 515, cause communication service monitor 500 to perform various functions described herein. The code may be stored in a non-transitory computer-readable medium such as system memory or another type of memory. In some cases, the code may not be directly executable by processor 515 but may cause a computer (e.g., when compiled and executed) to perform functions described herein. In some cases, the memory 520 may contain, among other things, a basic I/O system (BIOS) which may control basic hardware or software operation such as the interaction with peripheral components or devices.

Processor 515 may include an intelligent hardware device (e.g., a general-purpose processor), a digital signal processor (DSP), a central processing unit (CPU), a microcontroller, an application-specific integrated circuit (ASIC), a field programmable gate array (FPGA), a programmable logic device (PLD), a discrete gate or transistor logic component, a discrete hardware component, or any combination thereof. Processor 515 may be configured to execute computer-readable instructions stored in a memory (e.g., memory 520) to cause communication service monitor 500 to perform various functions (e.g., functions or tasks supporting monitoring of mobile satellite beam resource allocation). For example, processor 515 and memory 520 may be configured to perform the various functions described herein.

In some examples, instructions in the memory 520 may configure processor 515 to provide (e.g., via interface 530) a map 535 of a geographic area for display on an electronic display 540. Electronic display 540 may be co-located with computer 510 or may be positioned away from computer 510. In some examples, computer 510 may be directly coupled (e.g., via wired or wireless connection) with electronic display 540. In some examples, computer 510 may be indirectly coupled (e.g., via an internet connection) with electronic display 540.

The instructions in the memory 520 may configure processor 515 to obtain (e.g., via interface 525), respective geographic locations associated with mobile terminals 120 within the geographic area. In some examples, the geographic locations may be obtained directly (e.g., via wired or wireless connection) or indirectly (e.g., via an internet connection) from beam manager 175. In some examples, the geographic locations may be obtained directly or indirectly from satellite network 101. In some examples, respective geographic locations may be obtained for each of a plurality of time periods.

The instructions in the memory 520 may configure processor 515 to obtain (e.g., via interface 525), respective sets of information associated with the mobile terminals, or spot beams, or both. In some examples, the respective sets of information may be obtained directly (e.g., via wired or wireless connection) or indirectly (e.g., via an internet connection) from beam manager 175. In some examples, the respective sets of information may be obtained directly or indirectly from satellite network 101. In some examples, the respective sets of information may be obtained for each of a plurality of time periods.

In some examples, the respective sets of information may include indications of resource element allocations associated with the respective mobile terminals. In some examples, the respective sets of information may include one or more of: an indication of a respective signal to interference-and-noise ratio (SINR), an indication of a respective data rate of communication, an indication of a respective noise level, or an indication of a respective interference level associated with the respective mobile terminal.

The instructions in the memory 520 may configure processor 515 to provide to electronic display 540, respective icons 555 associated with the mobile terminals for display at respective positions on the map 535 representing the respective geographic locations of the mobile terminals. The icons 555 may be representative of the obtained information of the respective mobile terminals, or spot beams, or both. In some examples, the respective icons 555 may be provided to electronic display 540 for each of a plurality of time periods and may be representative of geographic locations and obtained information of the respective mobile terminals for the time period, as discussed herein. In some examples, the icons 555 may include visual representations of the indication of resource element allocations associated with respective mobile terminals. In some examples, electronic display 540 may display a visualization 560 including the map 535 and icons 555.

The instructions in the memory 520 may configure processor 515 to determine whether a metric of interference between pairs of mobile terminals satisfies a threshold. When the metric of interference reaches the threshold, it may indicate that to obviate or alleviate the interference, a deconfliction between the corresponding pair of mobile terminals may be desired. In some examples, the instructions in the memory 520 may configure processor 515 to provide to electronic display 540, respective visual representations associated with pairs of mobile terminals for which the metric of interference satisfies the threshold. In some examples, the respective visual representations associated with the pairs of mobile terminals may be provided to electronic display 540 for each of the plurality of time periods and may identify the pairs of mobile terminals for which the metric of interference satisfies the threshold for the time period.

In some examples, the metric of interface may include a distance between mobile terminals. The threshold interference distance may represent how close two terminals may get before a deconfliction may be desired. The instructions in the memory 520 may configure processor 515 to obtain (e.g., from beam manager 175) a threshold interference distance associated with the mobile terminals.

The instructions in the memory 520 may configure processor 515 to receive an indication of a click event associated with a respective icon. The click event may be received, e.g., from an input device (e.g., from a keyboard 545 or mouse 550) associated with electronic display 540. In some examples, in response to the click event, the instructions in the memory 520 may configure processor 515 to provide to electronic display 540, a set of information associated with the mobile terminal associated with the respective icon.

In some examples, one or both of interfaces 525 and 530 may be wired interfaces. In some examples, one or both of interfaces 525 and 530 may be a wireless interfaces. In some examples, the features of interfaces 525 and 530 may be combined in a single interface.

In some examples, electronic display 540 and/or corresponding input devices (e.g., keyboard 545, and/or mouse 550) may be considered to be a part of communication service monitor 500. In other examples, electronic display 540 and/or corresponding input devices (e.g., keyboard 545, and/or mouse 550) may not be considered to be a part of communication service monitor 500.

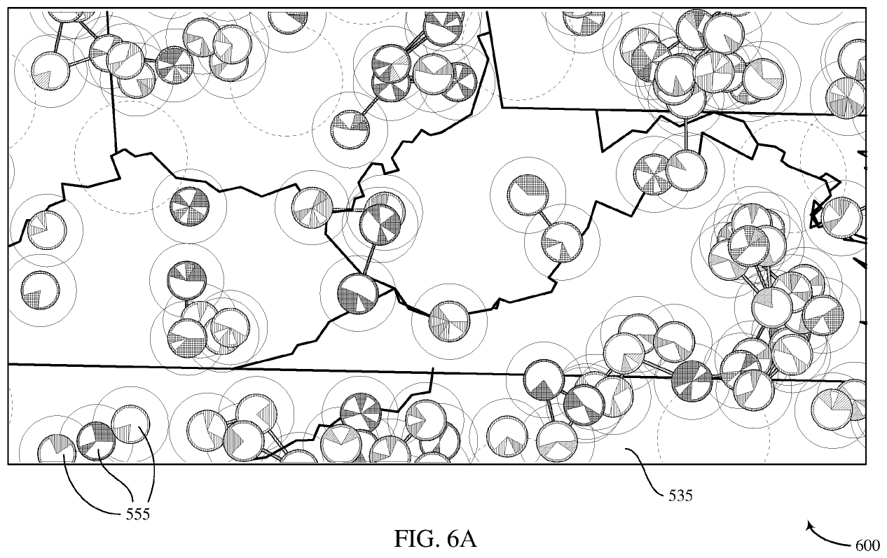

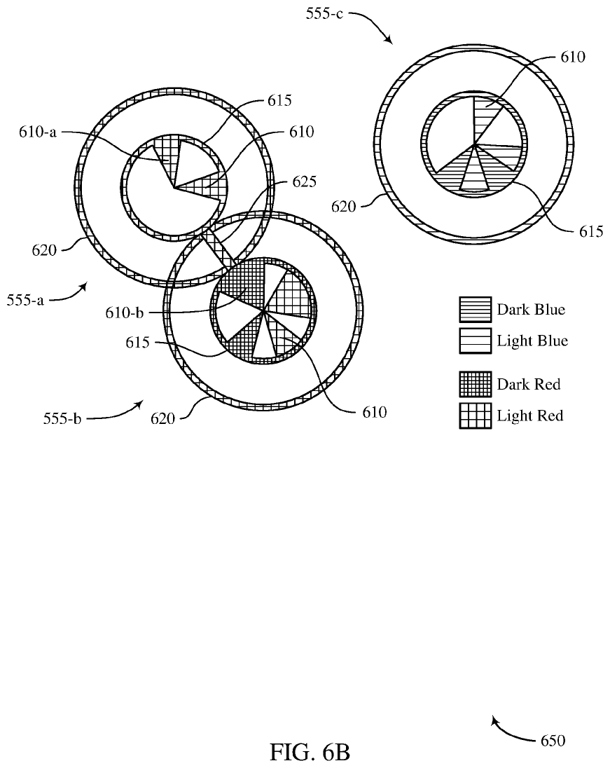

FIGS. 6A and 6B show examples of visualizations 600, 650 that support monitoring mobile satellite beam resource allocation in accordance with examples as disclosed herein. The visualization 600 may be an example of the visualization 560 described with reference to FIG. 5. Visualization 600 may represent information associated with mobile terminals (e.g., mobile terminals 120) for a time period and may be displayed on an electronic display (e.g., electronic display 540). Some or all of visualization 600 may be provided to the electronic display by communication service monitor 500 (e.g., as discussed with respect to FIG. 5). For example, visualization 600 may include a map 535 and a set of icons 555 provided to the electronic display by communication service monitor 500 for the time period. Each icon 555 may represent a respective mobile terminal and may be displayed at a respective position on map 535 representing the respective geographic location of the mobile terminal for the time period. For ease of discussion, FIG. 6B is included and shows greater detail associated with icons 555. In some embodiments, each icon 555 may be disc-shaped.

Each icon 555 may include a visual representation of the indication of respective one or more resource elements associated with the respective mobile terminal. In some examples, the respective one or more resource elements may include, e.g., combinations of time slots, frequency channels, polarizations, or codes associated with the mobile terminal. In some examples, each icon 555 may represent resources assigned to a beam (e.g., associated with a mobile terminal) across at least two dimensions such as time and frequency. In some examples, each icon 555 may represent resources assigned to the beam across more than two dimensions (e.g., more than two of time, frequency, power, and polarization).

In some examples, the set of resource elements may include resource element combinations that include time slots allocated to the mobile terminals. In those examples, the indication of the one or more resource elements associated with a mobile terminal may include an indication of one or more time slots allocated to the mobile terminal. In some examples, the visual representation of the indication of the one or more resource elements associated with the mobile terminal may include one or more wedges 610 of a circle 615, representative of the one or more time slots, as shown in FIG. 6B. In some examples, each wedge may represent a respective time slot allocated to the mobile terminal (e.g., at least one of an angular position, a color, a shading or a shape of the wedge may be based on the respective time slot). For example, wedges of a circle may represent time slots (e.g., t₁, t₂, . . . tₘ) of a time period 215 (e.g., repeating time period) as shown in FIG. 2.

In some examples, the set of resource elements may include resource element combinations that include frequency channels allocated to the mobile terminals. In those examples, the indication of the one or more resource elements associated with a mobile terminal may include an indication of one or more frequency channels associated with the mobile terminal. In some examples, the visual representation of the indication of the one or more resource elements associated with the mobile terminal may include one or more colors of the icon, representative of the one or more frequency channels. Each color may represent a respective frequency channel. For example, in FIG. 6B, icons 555-a and 555-b may both be displayed in a same color (e.g., red), which may signify that the mobile terminals represented by icons 555-a and 555-b may be associated with a same frequency channel. Icon 555-c may be displayed in a different color (e.g., blue), which may signify that the mobile terminal represented by icon 555-c may be associated with a different frequency channel.

In some examples, a power level associated with a frequency channel may be represented by a shading of the color. For example, for the mobile terminal represented by icon 555-c, the power level associated with two time slots may be at full power, while the power level associated with the other three time slots may be at a lower level, as reflected by the different shades of blue associated with the wedges 610 of icon 555-c.

Additionally or alternatively to frequency channels, different polarizations may be represented by different colors. For example, different combinations of frequency channels and polarizations may each be assigned to different colors. As discussed below, colors may be used to indicate mobile terminals that may be at risk of interfering with each other when they get close to each other.

In some examples, one or more icons 555 may include an indication of one or more of: an SINR, a respective data rate of communication, a respective noise level, or a respective interference level associated with the respective mobile terminal. In some examples, the visual representation of the indication of one or more of: an SINR, a respective data rate of communication, a respective noise level, or a respective interference level may include one or more colors of the icon. In some examples, shading may represent quantities associated with information having continuous quantities.

In some examples, visualization 600 may include visual representations linking pairs of mobile terminals for which a metric of interference satisfies a threshold. This may help the viewer of visualization 600 to determine when deconflictions may be desired and for which mobile terminals. In some examples, the visual representation may include a line segment extending between a pair of icons 555 that represent the pair of mobile terminals for which the metric of interference satisfies the threshold. For example, in FIG. 6B a line segment 625 extends between icons 555-a and 555-b, which may signify that a metric of interference between the mobile terminals represented by icons 555-a and 555-b may satisfy a threshold (e.g., due to the mobile terminals being close to each other while using a same frequency channel—reflected by icons 555-a and 555-b having the same color—and an overlapping time slot—represented by wedges 610-a and 610-b being in the same location of the respective circles 615 of icons 555-a and 555-b).

In some examples, the metric of interference may be based on the distance between the mobile terminals. In some examples, icons 555 may include a visual representation of a threshold interference distance associated with the mobile terminals. The threshold interference distance may represent how close two terminals may get before a deconfliction may be desired. For example, if two mobile terminals are associated with a same resource element, a deconfliction may be desired when the two mobile terminals get within the threshold interference distance from each other. In some examples, each icon may include a circle 620 (e.g., an outer circle) having a radius corresponding to the threshold interference distance, as shown in FIG. 6B. In some examples, the circle 620 may be the same color as the icon. For example, the circles 620 associated with icons 555-a and 555-b may be blue and the circle 620 associated with icon 555-c may be red. In some examples, when the icons representing two mobile terminals that are associated with a same resource element fall within the circles 620 of the other terminal, a deconfliction may be desired. For example, a deconfliction may be desired between the mobile terminals represented by icons 555-a and 555-b, as discussed herein. For example, time slots assigned to one of the terminals represented by icons 555-a and 555-b may be adjusted such that the assigned time slots to the terminals do not overlap in time.

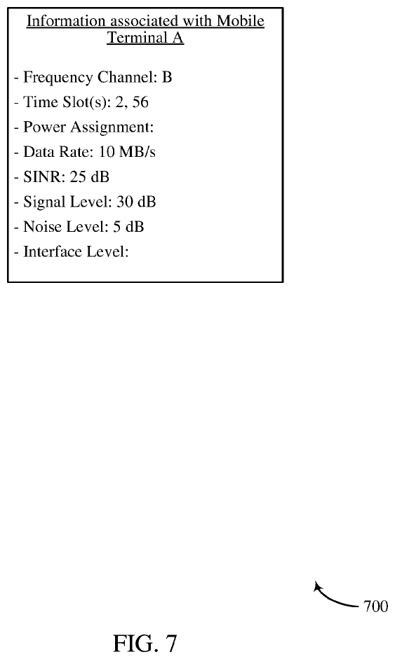

FIG. 7 illustrates an example representation 700 of a set of information associated with a mobile terminal that supports monitoring mobile satellite beam resource allocation in accordance with examples as disclosed herein. The representation may reflect information associated with a mobile terminal (e.g., a mobile terminal 120) for a time period and may be displayed on an electronic display (e.g., electronic display 540). The information may be provided to the electronic display by communication service monitor 500 (e.g., as discussed with respect to FIG. 5). In some examples, the information may be displayed in response to a click event of an icon (e.g., an icon 555) representative of the mobile terminal.

The set of information displayed by representation 700 may include indications of one or more resource elements associated with the respective terminal for the time period. For example, the set of information may include one or more frequency channel, time slot, polarization, or code associated with the one or more resource elements. In some examples, set of information may include one or more of: a power assignment, an SINR, a data rate, a signal level, a noise level, or an interference level associated with the mobile terminal. Other information may also be displayed.

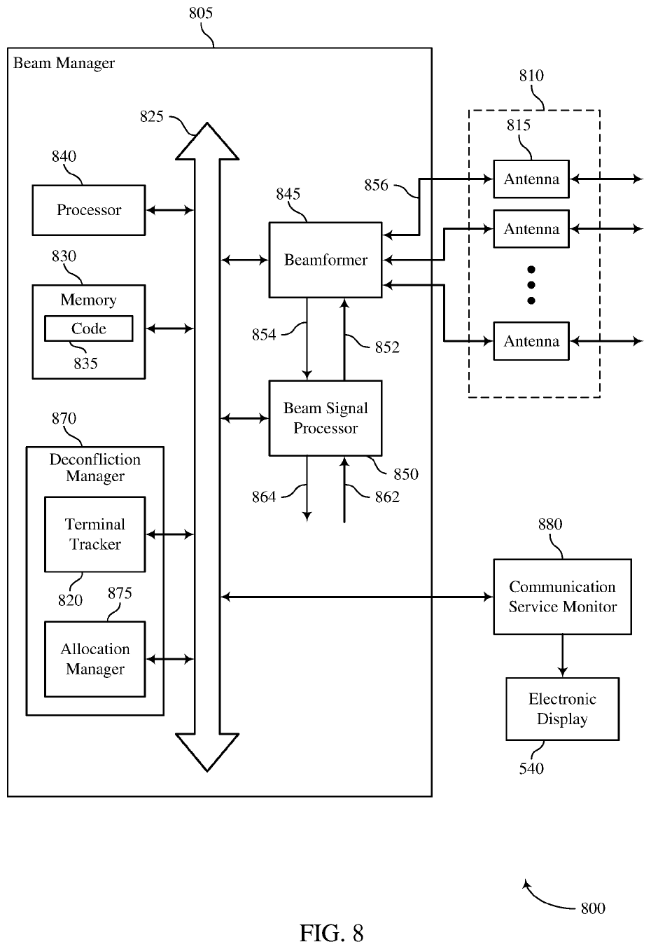

FIG. 8 shows a block diagram 800 of a beam manager 805 and a communication service monitor 880 that supports monitoring mobile satellite beam resource allocation in accordance with examples as disclosed herein. Beam manager 805 may be an example of beam manager 175 of FIG. 1. Beam manager 805 may include a bus 825, a deconfliction manager 870, a memory 830, code 835, a processor 840, a beamformer 845, and a beam signal processor 850, and may be configured to control beam tracking of mobile terminals (e.g., mobile terminals 120); and resource allocation and deconfliction of spot beams (e.g., spot beams 150) via an antenna array 810.

Beam manager 805 may be located within a ground network (e.g., ground network 135 of FIG. 1) or a satellite network (e.g., satellite network 101 of FIG. 1) of the satellite communications system. Alternatively, beam manager 805 may be divided between the ground network and the satellite network. In one example (e.g., corresponding to a GBBF configuration), all of the components of beam manager 805 may be located in the ground network. In another example (e.g., corresponding to an OBBF configuration), the beamformer 845 may be located in the satellite network (e.g., in one or more of the satellites) and the rest of the components of beam manager 805 may each be located in either the ground network or the satellite network. In some examples, a distributed implementation may be used. For example, one or more components or portions thereof of beam manager 805 may reside on different servers (e.g., hosted in the cloud). In some examples, beam manager 805 may be located at a single entity.

Antenna array 810 may be an example of the antennas of the satellite network 101 of FIG. 1 and may include antenna elements 815. In some examples, one or more of the antenna elements 815 may be or include an antenna panel. The spacing between antenna elements 815 may be evenly distributed across an aperture of antenna array 810, or the spacing of antenna elements 815 may be different across antenna array 810. In some examples, a first antenna array 810 may be included within the ground segment and a second antenna array 810 (e.g., one or more antenna arrays coupled with each other using transponders) may be included within the space segment.

Communication service monitor 880 may be an example of communication service monitor 500 described with reference to FIG. 5. As discussed in more detail with respect to FIG. 5, communication service monitor 880 may obtain via beam manager 805, information (e.g., locations, resource element allocations, and/or other information) associated with mobile terminals for display on electronic display 540. In some examples, this information may be obtained from deconfliction manager 870. In some examples, communication service monitor 880 may be a separate entity from beam manager 805. In some examples, communication service monitor 880 may be combined with beam manager 805.

Bus 825 may represent an interface over which signals may be exchanged between components of beam manager 805 and a location that may be used to distribute the signals to the signal processing components of beam manager 805 (e.g., deconfliction manager 870, beam signal processor 850, beamformer 845). Bus 825 may also be used to exchange information with communication service monitor 880. Bus 825 may include one or more wired interfaces. Additionally, or alternatively, bus 825 may be a wireless interface that is used to wirelessly communicate signaling between the signal processing components—e.g., in accordance with a communication protocol. Beamformer 845 may be coupled with antenna elements 815 via one or more wired or wireless interfaces. In some examples, deconfliction manager 870 (or other portion of beam manager 805) may be coupled with communication service monitor 880 via a wired or wireless interface.

The memory 830 may include volatile memory (e.g., RAM) and/or non-volatile memory (e.g., ROM). Other types of memory may also be possible. The memory 830 may store code 835 that is computer-readable and computer-executable. The code may include instructions that, when executed by processor 840, cause beam manager 805 to perform various functions described herein. The code 835 may be stored in a non-transitory computer-readable medium such as system memory or another type of memory. In some cases, the code 835 may not be directly executable by processor 840 but may cause a computer (e.g., when compiled and executed) to perform functions described herein. In some cases, the memory 830 may contain, among other things, a BIOS which may control basic hardware or software operation such as the interaction with peripheral components or devices.

Processor 840 may include an intelligent hardware device (e.g., a general-purpose processor), a DSP, a CPU, a microcontroller, an ASIC, an FPGA, a PLD, a discrete gate or transistor logic component, a discrete hardware component, or any combination thereof. Processor 840 may be configured to execute computer-readable instructions stored in a memory (e.g., memory 830) to cause beam manager 805 to perform various functions (e.g., functions or tasks supporting mobile satellite beam resource allocation). For example, processor 840 and memory 830 may be configured to perform the various functions described herein.

Beam signal processor 850 may be configured to process (e.g., demodulate, decode) receive beam signals 854 received from beamformer 845. Beam signal processor 850 may decode data symbols included in the receive beam signals 854 to obtain receive beam data signals 864. Information (e.g., packets) in receive beam data signals 864 may be passed (e.g., via network(s) 125) to a destination device. Beam signal processor 850 may also be configured to process (e.g., encode, modulate) transmit beam data signals 862 to obtain transmit beam signals 852 to send to beamformer 845. Transmit beam data signals 862 may include information (e.g., packets) received (e.g., via network(s) 125) for transmission to terminals 120.

Deconfliction manager 870 may be configured to determine resource element changes for each beam and direct the execution of those resource element changes. For example, if a new time slot is to be assigned to a beam, deconfliction manager 870 may compute new beamforming coefficients based on CSI from all the beams active in that time slot and may also determine desired power, modulation and/or coding for that time slot, either by calculation or by requesting signal-to-noise ratio reports from the terminal associated with the beam. In another example, if a beam is to be moved to a new frequency range or channel, then the CSI and beamforming coefficients from the old channel may be inapplicable in the new channel due to variability of RF characteristics from channel to channel. Deconfliction manager 870 may cause channel probing signals to be transmitted in the new frequency channel and instruct the terminal associated with the beam to: switch to the new channel, process the probing signal, switch back to the original channel, and report the CSI information back to beam manager 805. To avoid packet loss during this operation, the scheduling of data packets may be paused during the reception of the channel probe signal in the new channel. Deconfliction manager 870 may include a terminal tracker 820 and an allocation manager 875.

Terminal tracker 820 may be configured to determine information for beamformer 845 to use in forming spot beams (e.g., spot beams 150 of FIG. 1) using antenna elements 815. To determine the information for forming the spot beams, terminal tracker 820 may identify a set of terminals (e.g., mobile terminals 120 of FIG. 1) to be assigned as reference terminals, and may determine spatial information associated with the reference terminals. Terminal tracker 820 may determine a set of beamforming coefficients (e.g., phase shifts, amplitude components) that beamformer 845 may use to generate spot beams having individual coverage areas directed to the spatial information associated with the reference terminals.

Terminal tracker 820 may determine the beamforming coefficients to isolate signals transmitted over spot beams from one another—e.g., by, for each spot beam, emphasizing the signals transmitted within the spot beam and canceling interference from signals transmitted within other spot beams. The beamforming coefficients may be included in an M×N matrix, where a value of M may indicate the quantity of antennas and a value of N may indicate the quantity of spatial layers, where the value of N may be less than or equal to the value of M.

In some examples, the beamforming coefficients may be determined at the one or more satellites 105. In some examples, the beamforming coefficients may be received by the one or more satellites from one or more ground stations (e.g., network devices 130 or other stations of ground network 135) after terminal tracker 820 determines the beamforming coefficients. In some examples, terminal positioning information may be obtained from terminal tracker 820 by communication service monitor 880.

Allocation manager 875 may be configured to perform beam resource allocation and reallocation, including coordinating resource elements used by the beams. For example, allocation manager 875 may determine, for allocation of each spot beam: one or more frequency ranges or channels (e.g., a frequency channel 210 of FIG. 2B); one or more time periods and/or time slots (e.g., time period 215, time slot t of FIG. 2B); and/or a polarity. To allocate the beams to the determined resource elements, allocation manager 875 may include various components, such as frequency converters, schedulers, and polarization components.

Allocation manager 875 may be further configured to keep track of which resource elements are assigned to which spot beams and to determine when reallocation of a resource element may be desired. In some examples, resource element allocation information may be obtained from allocation manager 875 by communication service monitor 880.

Allocation manager 875 may be further configured to allocate power to the beams. For example, allocation manager 875 may allocate power to the beams based on link impairments of the mobile terminals associated with the beams.

In some examples, for transmission of spot beams via antenna elements 815, allocation manager 875 may determine frequency ranges or channels and time periods and time slots for applying to a set of transmit beam signals 852 associated with the spot beams. Beamformer 845 may apply, based on the frequency ranges or channels, the set of transmit beamforming coefficients to the set of transmit beam signals 852 to obtain component signals 856 for transmission via antenna elements 815.

In some examples, for reception of spot beams via antenna elements 815, terminal tracker 820 may determine a set of receive beamforming coefficients, based on frequency ranges or channels determined by allocation manager 875, to obtain a set of component signals 856. The frequency ranges or channels and time slots may be applied to the component signals 856 by allocation manager 875 or beamformer 845 to obtain a set of receive beam signals 854 associated with the spot beams.

In some examples, terminal tracker 820, allocation manager 875, beamformer 845, beam signal processor 850, or various combinations or components thereof, may be implemented in hardware (e.g., in communications management circuitry). The hardware may include a processor, a DSP, an ASIC, an FPGA or other PLD, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, terminal tracker 820, allocation manager 875, beamformer 845, beam signal processor 850, or various combinations or components thereof, may be implemented in code 835 (e.g., as communications management software or firmware), executed by processor 840. If implemented in code 835 executed by processor 840, the functions of terminal tracker 820, allocation manager 875, beamformer 845, beam signal processor 850, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

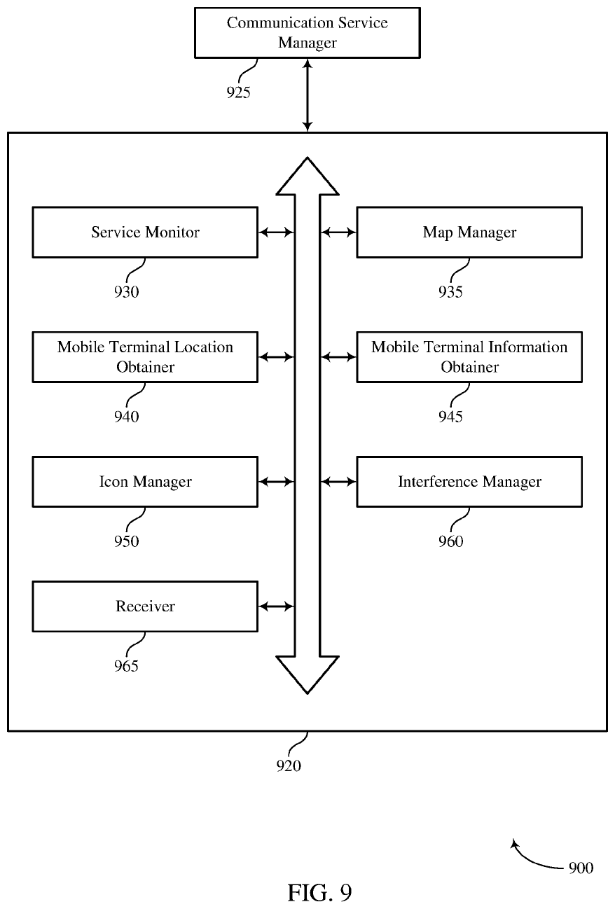

FIG. 9 shows a block diagram 900 of a communication service monitor 920 that supports monitoring mobile satellite beam resource allocation in accordance with examples as disclosed herein. Communication service monitor 920 may be an example of aspects of communication service monitors 500 and 880 as described with reference to FIGS. 5 and 8. Communication service monitor 920, or various components thereof, may be an example of means for performing various aspects of monitoring mobile satellite beam resource allocation as described herein.

For example, communication service monitor 920 may include a service monitor 930, a map manager 935, a mobile terminal location obtainer 940, a mobile terminal information obtainer 945, an icon manager 950, an interference manager 960, a receiver 965, or any combination thereof. Each of these components may communicate, directly or indirectly, with one another (e.g., via one or more buses).

The service monitor 930 may be configured as or otherwise support a means for monitoring a communication service, as discussed herein. In some examples, the service monitor 930 may include one or more of the other components of communication service monitor 920. In some examples, the service monitor 930 may include the map manager 935, the mobile terminal location obtainer 940, the mobile terminal information obtainer 945, the icon manager 950, the interference manager 960, and the receiver 965.

The map manager 935 may be configured as or otherwise support a means for providing, for display on an electronic display, a map of a geographic area, as discussed herein.

The mobile terminal location obtainer 940 may be configured as or otherwise support a means for obtaining geographic locations of a set of mobile terminals within a geographic area, as discussed herein. The obtaining of the locations may be performed for each of a plurality of time periods. The obtaining of the geographic locations may be based on adjusting respective coverage areas of a set of spot beams to track movement of the mobile terminals.

The mobile terminal information obtainer 945 may be configured as or otherwise support a means for obtaining sets of information associated with respective mobile terminals, as discussed herein. The obtaining of the sets of information may be performed for each of a plurality of time periods. The sets of information may each include an indication of one or more resource elements associated with a respective mobile terminal. For example, a set of information may include indications of a time slot, a frequency channel, a polarization, a code, or a combination thereof associated with the mobile terminal. In some examples, the set of information may include a power value, an SINR, a data rate of communication, a noise level, an interference level, or a combination thereof associated with the mobile terminal.

The interference manager 960 may be configured as or otherwise support a means for determining whether a metric of interference between mobile terminals satisfies a threshold, as discussed herein. The interference manager 960 may also be configured as or otherwise support a means for obtaining a threshold interference distance associated with the plurality of mobile terminals, as discussed herein.

The icon manager 950 may be configured as or otherwise support a means for providing, for display on a map, icons associated with a set of mobile terminals, as discussed herein. The icons may be for display at respective positions on the map representing respective geographic locations of the mobile terminals. The icons may each include a visual representation of the indication of respective one or more resource elements associated with the respective mobile terminal. The icon manager 950 may also be configured as or otherwise support a means for providing, for display on the map, visualizations of links between mobile terminals, as discussed herein. For example, the visualizations may include a visual representation indicating interference between mobile terminals.

The receiver 965 may be configured as or otherwise support a means for receiving indications of click events. The indications may each correspond to a respective click event of one of the icons, as discussed herein. The receiving of an indication may be performed for at least one of a plurality of time periods. In some examples, the icon manager 950 may be configured as or otherwise support a means for providing another icon, for display, in response to the receiving of the indication of the click event. The other icon may include the set of information or a portion thereof associated with the mobile terminal associated with the icon associated with the click event.

Communication service monitor 920 may be coupled with a communication service manager 925. The communication service manager 925 may be configured as or otherwise support a means for providing, by a satellite communication system, a communication service to mobile terminals within a coverage area of the satellite communication system, as discussed herein. The providing of the communication service may be performed for a plurality of time periods. For each of the time periods, the mobile terminals may be associated with respective one or more resource elements. Each mobile terminal may be assigned to a spot beam. Communication service manager 925 may communicate, directly or indirectly, with one or more of the components of communication service monitor 920. In some examples, communication service monitor may include communication service manager 925.

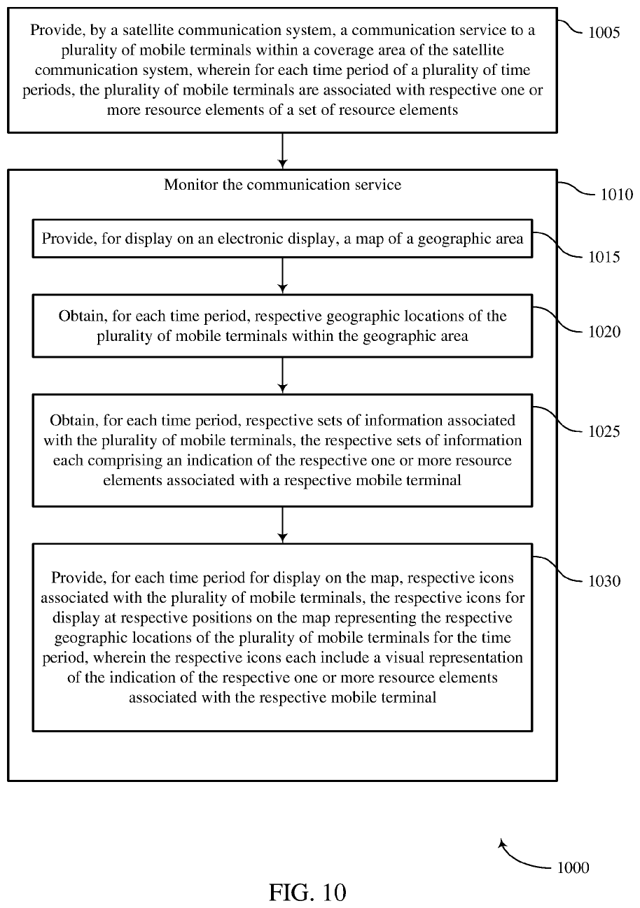

FIG. 10 shows a flowchart illustrating a method 1000 that supports monitoring mobile satellite beam resource allocation in accordance with examples as disclosed herein. The operations of the method 1000 may be implemented by a satellite communications system or its components as described herein. For example, the operations of method 1000 may be performed by a beam manager and communication service monitor as described with reference to FIGS. 1 through 9. In some examples, one or more processors may execute a set of instructions to control the functional elements of the beam manager and/or communication service monitor to perform the described functions. Additionally, or alternatively, the beam manager and/or communication service monitor may perform aspects of the described functions using special-purpose hardware.

At 1005, the method may include providing, by a satellite communication system, a communication service to a plurality of mobile terminals within a coverage area of the satellite communication system, wherein for each time period of a plurality of time periods, the plurality of mobile terminals are associated with respective one or more resource elements of a set of resource elements. The operations of 1005 may be performed in accordance with examples as disclosed herein. In some examples, aspects of the operations of 1005 may be performed by a communication service manager 925 as described with reference to FIG. 9. In some examples, aspects of the operations of 1005 may be performed by a deconfliction manager 870 as described with reference to FIG. 8.

At 1010, the method may include monitoring the communication service. The operations of 1010 may be performed in accordance with examples as disclosed herein. In some examples, aspects of the operations of 1010 may be performed by a service monitor 930 as described with reference to FIG. 9. In some examples, aspects of the operations of 1010 may be performed by a communication service monitor 500 as described with reference to FIG. 5. In some examples, monitoring the communication service may include the operations of 1015, 1020, 1025, and 1030.

At 1015, monitoring the communication service may include providing, for display on an electronic display, a map of a geographic area. The operations of 1015 may be performed in accordance with examples as disclosed herein. In some examples, aspects of the operations of 1015 may be performed by a map manager 935 as described with reference to FIG. 9. In some examples, aspects of the operations of 1015 may be performed by a communication service monitor 500 as described with reference to FIG. 5.

At 1020, monitoring the communication service obtaining, for each time period, respective geographic locations of the plurality of mobile terminals within the geographic area. The operations of 1020 may be performed in accordance with examples as disclosed herein. In some examples, aspects of the operations of 1020 may be performed by a mobile terminal location obtainer 940 as described with reference to FIG. 9. In some examples, aspects of the operations of 1020 may be performed by a communication service monitor 500 as described with reference to FIG. 5.

At 1025, monitoring the communication service may include obtaining, for each time period, respective sets of information associated with the plurality of mobile terminals, the respective sets of information each comprising an indication of the respective one or more resource elements associated with a respective mobile terminal. The operations of 1025 may be performed in accordance with examples as disclosed herein. In some examples, aspects of the operations of 1025 may be performed by a mobile terminal information obtainer 945 as described with reference to FIG. 9. In some examples, aspects of the operations of 1025 may be performed by a communication service monitor 500 as described with reference to FIG. 5.

At 1030, monitoring the communication service may include providing, for each time period for display on the map, respective icons associated with the plurality of mobile terminals, the respective icons for display at respective positions on the map representing the respective geographic locations of the plurality of mobile terminals for the time period, wherein the respective icons each include a visual representation of the indication of the respective one or more resource elements associated with the respective mobile terminal. The operations of 1030 may be performed in accordance with examples as disclosed herein. In some examples, aspects of the operations of 1030 may be performed by an icon manager 950 as described with reference to FIG. 9. In some examples, aspects of the operations of 1030 may be performed by a communication service monitor 500 as described with reference to FIG. 5.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the method or methods.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method comprising:
providing, by a satellite communication system, a communication service to a plurality of mobile terminals within a coverage area of the satellite communication system, wherein for each time period of a plurality of time periods, the plurality of mobile terminals are associated with respective one or more resource elements of a set of resource elements; and
monitoring the communication service, comprising:
providing, for display on an electronic display, a map of a geographic area;
obtaining, for each time period, respective geographic locations of the plurality of mobile terminals within the geographic area;
obtaining, for each time period, respective sets of information associated with the plurality of mobile terminals, the respective sets of information each comprising an indication of the respective one or more resource elements associated with a respective mobile terminal;
obtaining a threshold interference distance associated with the plurality of mobile terminals
providing, for each time period for display on the map, respective icons associated with the plurality of mobile terminals, the respective icons for display at respective positions on the map representing the respective geographic locations of the plurality of mobile terminals for the time period, wherein the respective icons each include a visual representation of the indication of the respective one or more resource elements associated with the respective mobile terminal, wherein the respective icons associated with the plurality of mobile terminals each includes, for at least one time period of the plurality of time periods, a respective visual representation of the threshold interference distance;
determining, for at least one time period of the plurality of time periods, for respective pairs of mobile terminals of the plurality of mobile terminals, whether a metric of interference between mobile terminals of the respective pair exceeds a threshold; and
for each respective pair of mobile terminals for which the metric of interference satisfies the threshold, providing, for the at least one time period, for display on the map, a respective second visual representation of a link between the mobile terminals of the respective pair of mobile terminals, based at least in part on the determination.

2. The method of claim 1, wherein the set of resource elements comprises combinations of time slots, frequency channels, polarizations, or codes associated with the plurality of mobile terminals.

3. The method of claim 1, wherein the set of resource elements comprises resource element combinations that include time slots allocated to the plurality of mobile terminals, and
wherein the indication of the respective one or more resource elements associated with the respective mobile terminal comprises, for at least one time period of the plurality of time periods, an indication of respective one or more time slots associated with the respective mobile terminal.

4. The method of claim 3, wherein the visual representation of the indication of the respective one or more resource elements associated with the respective mobile terminal comprises, for the at least one time period, a visual representation of the respective one or more time slots, comprising:
one or more wedges of a circle, wherein at least one of an angular position, a color, or a shape of each wedge is based on the respective one or more time slots.

5. The method of claim 1, wherein the set of resource elements comprises resource element combinations that include frequency channels allocated to the plurality of mobile terminals, and
wherein the indication of the respective one or more resource elements associated with the respective mobile terminal comprises, for at least one time period of the plurality of time periods, an indication of respective one or more frequency channels associated with the respective mobile terminal.

6. The method of claim 5, wherein the visual representation of the indication of the respective one or more resource elements associated with the respective mobile terminal comprises, for the at least one time period, a visual representation of the respective one or more frequency channels, comprising:
one or more colors of the respective icon, based on the respective one or more frequency channels.

7. (canceled)

8. The method of claim 1, wherein the visual representation of the threshold interference distance comprises, for the at least one time period:
a circle centered at the respective position on the map representing a geographic location of the respective mobile terminal, the circle having a radius on the map corresponding to the threshold interference distance.

9. (canceled)

10. The method of claim 1, wherein the metric of interference comprises a distance between the mobile terminals of the respective pairs of mobile terminals.

11. The method of claim 1, wherein the respective second visual representation of the link between the mobile terminals of the respective pair of mobile terminals comprises, for the at least one time period:
a line segment between the respective icons associated with the mobile terminals of the respective pair of mobile terminals.

12. The method of claim 1, wherein the respective sets of information each further comprises, for at least one time period of the plurality of time periods, an indication of a respective power value allocated to a respective spot beam associated with the respective mobile terminal, and
wherein the respective icons associated with the plurality of mobile terminals each includes, for the at least one time period, a visual representation of the respective power value associated with the respective spot beam associated with the respective mobile terminal.

13. The method of claim 1, wherein, for at least one time period of the plurality of time periods, the respective sets of information each further comprise at least one of an indication of a respective signal to interference-and-noise ratio (SINR), an indication of a respective data rate of communication, an indication of a respective noise level, or an indication of a respective interference level associated with the respective mobile terminal, and
wherein the respective icons associated with the plurality of mobile terminals each includes, for the at least one time period, a visual representation of the at least one of the indication of the respective SINR, the indication of the respective data rate of communication, the indication of the respective noise level, or the indication of the respective interference level associated with the respective mobile terminal.

14. The method of claim 13, wherein the visual representation of the at least one of the indication of the respective SINR, the indication of the respective data rate of communication, the indication of the respective noise level, or the indication of the respective interference level comprises, for the at least one time period:
one or more colors of the respective icon, based on the at least one of the indication of the respective SINR, the indication of the respective data rate of communication, the indication of the respective noise level, or the indication of the respective interference level.

15. The method of claim 1, wherein the respective icons associated with the respective mobile terminals each comprises, for at least one of the plurality of time periods:
one or more wedges of a circle, wherein at least one of an angular position, a color, or a shape of each wedge is based on one or more time slots allocated to the respective mobile terminal;
one or more colors of the respective icon, based on one or more frequency channels allocated to the respective mobile terminal; and
an outer circle centered at the respective position on the map representing a geographic location of the respective mobile terminal, the circle having a radius on the map corresponding to a threshold interference distance associated with the plurality of mobile terminals.

16. The method of claim 1, wherein monitoring the communication service further comprises:
receiving, for at least one of the plurality of time periods, an indication of a click event of one of the respective icons; and providing, for display, in response to the receiving the indication of the click event, a second set of information associated with the mobile terminal associated with the one of the respective icons, wherein the second set of information includes the respective set of information associated with the mobile terminal.

17. The method of claim 1, wherein:
each spot beam of a set of spot beams is associated with a respective mobile terminal of the plurality of mobile terminals, and
respective coverage areas of the set of spot beams are adjusted over the plurality of time periods to track movement of the respective mobile terminals.

18. A system for satellite communications, comprising:
one or more satellites;
a beam manager coupled with the one or more satellites and configured to provide a communication service to a plurality of mobile terminals within a coverage area of the system for satellite communications, wherein for each time period of a plurality of time periods, the plurality of mobile terminals are associated with respective one or more resource elements of a set of resource elements; and
a communication service monitor configured to monitor the communication service, wherein to monitor the communication service, the communication service monitor is configured to:
provide, for display on an electronic display, a map of a geographic area;
obtain, for each time period, respective geographic locations of the plurality of mobile terminals within the geographic area;
obtain, for each time period, respective sets of information associated with the plurality of mobile terminals, the respective sets of information each comprising an indication of the respective one or more resource elements associated with the respective mobile terminal;
obtain a threshold interference distance associated with the plurality of mobile terminals;
provide, for each time period for display on the map, respective icons associated with the plurality of mobile terminals, the respective icons for display at respective positions on the map representing the respective geographic locations of the plurality of mobile terminals for the time period, wherein the respective icons each include a visual representation of the indication of the respective one or more resource elements associated with the respective mobile terminal, and wherein the respective icons associated with the plurality of mobile terminals each includes, for at least one time period of the plurality of time periods, a respective visual representation of the threshold interference distance;
determine, for at least one time period of the plurality of time periods, for respective pairs of mobile terminals of the plurality of mobile terminals, whether a metric of interference between the mobile terminals of the respective pair exceeds a threshold; and
for each respective pair of mobile terminals for which the metric of interference satisfies the threshold, provide, for the at least one time period, for display on the map, a second visual representation of a link between the mobile terminals of the respective pair of mobile terminals, based at least in part on the determination.

19. The system of claim 18, wherein the set of resource elements comprises combinations of time slots, frequency channels, polarizations, or codes associated with the plurality of mobile terminals.

20. The system of claim 18, wherein the set of resource elements comprises resource element combinations that include time slots allocated to the plurality of mobile terminals, and
wherein the indication of the respective one or more resource elements associated with the respective mobile terminal comprises, for at least one time period of the plurality of time periods, an indication of respective one or more time slots associated with the respective mobile terminal.

21. The system of claim 20, wherein the visual representation of the indication of the respective one or more resource elements associated with the respective mobile terminal comprises, for the at least one time period, a visual representation of the respective one or more time slots, comprising:
one or more wedges of a circle, wherein at least one of an angular position, a color, or a shape of each wedge is based on the respective one or more time slots.

22. The system of claim 18, wherein the set of resource elements comprises resource element combinations that include frequency channels allocated to the plurality of mobile terminals, and
wherein the indication of the respective one or more resource elements associated with the respective mobile terminal comprises, for at least one time period of the plurality of time periods, an indication of respective one or more frequency channels associated with the respective mobile terminal.

23. The system of claim 22, wherein the visual representation of the indication of the respective one or more resource elements associated with the respective mobile terminal comprises, for the at least one time period, a visual representation of the respective one or more frequency channels, comprising:
one or more colors of the respective icon, based on the respective one or more frequency channels.

24. (canceled)

25. The system of claim 18, wherein the visual representation of the threshold interference distance comprises, for the at least one time period:
a circle centered at the respective position on the map representing a geographic location of the respective mobile terminal, the circle having a radius on the map corresponding to the threshold interference distance.

26. (canceled)

27. The system of claim 18, wherein the metric of interference comprises a distance between the mobile terminals of the respective pairs of mobile terminals.

28. The system of claim 27, wherein the respective second visual representation of the link between the mobile terminals of the respective pair of mobile terminals comprises, for the at least one time period:
a line segment between the respective icons associated with the mobile terminals of the respective pair of mobile terminals.

29. The system of claim 18, wherein the respective sets of information each further comprises, for at least one time period of the plurality of time periods, an indication of a respective power value allocated to a respective spot beam associated with the respective mobile terminal, and
wherein the respective icons associated with the plurality of mobile terminals each includes, for the at least one time period, a visual representation of the respective power value associated with the respective spot beam associated with the respective mobile terminal.

30. The system of claim 18, wherein, for at least one time period of the plurality of time periods, the respective sets of information each further comprise at least one of an indication of a respective signal to interference-and-noise ratio (SINR), an indication of a respective data rate of communication, an indication of a respective noise level, or an indication of a respective interference level associated with the respective mobile terminal, and
wherein the respective icons associated with the plurality of mobile terminals each includes, for the at least one time period, a visual representation of the at least one of the indication of the respective SINR, the indication of the respective data rate of communication, the indication of the respective noise level, or the indication of the respective interference level associated with the respective mobile terminal.

31. The system of claim 30, wherein the visual representation of the at least one of the indication of the respective SINR, the indication of the respective data rate of communication, the indication of the respective noise level, or the indication of the respective interference level comprises, for the at least one time period:
one or more colors of the respective icon, based on the at least one of the indication of the respective SINR, the indication of the respective data rate of communication, the indication of the respective noise level, or the indication of the respective interference level.

32. The system of claim 18, wherein the respective icons associated with the respective mobile terminals each comprises, for at least one of the plurality of time periods:
one or more wedges of a circle, wherein at least one of an angular position, a color or a shape of each wedge is based on one or more time slots allocated to the respective mobile terminal;
one or more colors of the respective icon, based on one or more frequency channels allocated to the respective mobile terminal; and
an outer circle centered at the respective position on the map representing a geographic location of the respective mobile terminal, the circle having a radius on the map corresponding to a threshold interference distance associated with the plurality of mobile terminals.

33. The system of claim 18, wherein to monitor the communication service, the communication service monitor is further configured to:
receive, for at least one of the plurality of time periods, an indication of a click event of one of the respective icons; and
provide, for display, in response to the receiving the indication of the click event, a second set of information associated with the mobile terminal associated with the one of the respective icons, wherein the second set of information includes the respective set of information associated with the mobile terminal.

34. The system of claim 18, wherein:
each spot beam of a set of spot beams is associated with a respective mobile terminal of the plurality of mobile terminals, and
respective coverage areas of the set of spot beams are adjusted over the plurality of time periods to track movement of the respective mobile terminals.
